(19) United States
(12) Patent Application Publication
(10) Pub. No.: US 2019/0094119 A1
(43) Pub. Date: Mar. 28, 2019

(54) PIPE RHEOMETER

(71) Applicant: Schlumberger Technology Corporation, Sugar Land, TX (US)

(72) Inventors: Manat Singh, Houston, TX (US); Jacques Orban, Houston, TX (US)

(21) Appl. No.: 15/714,291

(22) Filed: Sep. 25, 2017

(51) Int. Cl. G01N 11/04; G01F 1/66; G01F 1/696

(52) U.S. Cl. CPC G01N 11/04; G01F 1/696; G01F 1/667

(57) ABSTRACT

A system for measuring rheological characteristics for drilling muds without the use of a delicate, expensive, or labor-intensive viscometer is disclosed. The system includes a fluid diverter circuit which retrieves a sample of the drilling mud and stores it in a reservoir where the pressure and level of the drilling mud are measured. The reservoir drains through a measurement pipe which enables a calculation of a flow rate. With the dimensions of the measurement pipe, the pressure, and the flow rate, a rheological chart can be assembled. The system can iteratively measure pressure and from the iterative data achieve a non-Newtonian factor, n′, confirm entrance length of the measurement pipe, and confirm that the flow in the measurement pipe is laminar.

### BACKGROUND

Drilling operations in the oilfield utilize drilling fluids, or mud, for a variety of purposes. Drilling fluid, or mud, is defined as any of a number of liquid and mixtures of fluids and solids (as solid suspensions, mixtures and emulsions of liquids, gases and solids) used in operations to drill boreholes into the earth. Synonymous with “drilling fluid” in general usage, although some prefer to reserve the term “drilling fluid” for more sophisticated and well-defined “muds.” One key classification scheme is based only on the composition of the liquid phase of the mud which affects strongly the reactivity with some formations: (1) water-base and (2) non-water-base. Drilling fluids and muds are referred to herein as “mud” without loss of generality. In some application, the drilling fluid may-be “aerated” or foamed. The foaming gas phase is typically nitrogen. The mud may be “aerated” or “foamed” with nitrogen to lower the density below the typical density of water or diesel. However, the void fraction of such foam depends strongly on the pressure. The rheology of such fluid I strongly depending on the void fraction of the foam. This void fraction may be controlled during lab testing such as rheometer to simulate equivalent void fraction in down-hole conditions (pressure and temperature). In other instances of operations related to oil & gas activities, cement slurry, brine and frac fluid may be pumped.

One important characteristic for liquid to monitor is its viscosity, or rheology. Rheology is the branch of physics that deals with the deformation and flow of matter, especially the non-Newtonian flow of liquids and the plastic flow of solids. Many muds are non-Newtonian and therefore their rheology must be determined by measurements at different shear conditions. Rheology also addresses the thixotropic aspects of these liquids: the rheology behavior depends on the shear history. It is critical to control the duration of the tests. Also, the gelling of the thixotropic fluid may have to be measured. Specific devices and measurement processes allow to measure the rheology of such fluid. Rotary viscometers provide the benefit of proper control of the shear conditions (shear rate and shear stress) across the whole volume. Also, a given shear condition may be maintained for a selected time.

Rotational viscometers are one example of such a device, one popular version is called the Fann 35 viscometer. Rotational viscometers such as the Fann 35 and other similar devices, however, present certain challenges including being error prone and include delicate parts such as springs. These devices rely on precise torque measurement (IE torsion spring), and rely on placing the measured fluid through very small gaps between concentric cylinders which rotate relative to one another to measure viscosity. These devices are delicate and also require a trained engineer to operate reliably. Any deformation or clogging of such a device would render it unable to measure rheology properly. There is a need in the art for a technique of reliably measuring viscosity/rheology of mud that is unaffected by the relatively harsh environment of the oilfield, nor the availability and technical expertise of a mud engineer. Pipe rheometer is an alternative method to obtain fluid rheology, by typically measuring flow rate and pressure drop for a flow through a pipe of a given geometry. With realistic design, the pressure drop is quite low, requiring high resolution pressure gauge which may be fragile.

### SUMMARY

Various features of the present disclosure are described herein with reference to the figures. Certain embodiments of the present disclosure are directed to a system for measuring a rheological profile for a fluid. The system includes a reservoir that receives a sample of the fluid. The reservoir has a height and a volume. The system also includes a measurement pipe operably coupled to the reservoir and configured to conduct fluid from the reservoir. The measurement pipe has an interior dimension and a length. There is a pressure determination component operably coupled to the reservoir and configured to determine a pressure in the reservoir as it enters the measurement pipe at a plurality of different times as fluid leaves the reservoir, and a flow rate determination component operably coupled to at least one of the measurement pipe and the reservoir and configured to monitor a flow rate through the measurement pipe. The system further includes a sequencing component configured to fill the reservoir and to permit gravity drainage of the reservoir at drainage rate reducing during the drainage phase. The system also includes a data acquisition system configured to determine a pressure and flow-rate at various discrete times during the drainage of the fluid from the reservoir and after filling of the reservoir, and a computation component configured to create a plot of shear stress and shear rate from the variables P, pressure taken at the plurality of different times by the pressure measuring component, Q, the flow rate measured by the flow rate measuring component.

Other embodiments of the present disclosure are directed to methods for measuring a rheological graph of a fluid, including retrieving a sample of fluid from a body of fluid and at least partially filling a reservoir with the sample of fluid. The method also includes draining the sample of fluid from the reservoir through a measurement pipe and monitoring a level of fluid in the reservoir as the reservoir is drained, thereby determining a flow rate through the measurement pipe. The method includes identifying a pressure within the reservoir at a plurality of measurements as the reservoir is drained, calculating a shear stress for the sample of fluid from the identified pressure drop along rheometer pipe, calculating a non-Newtonian factor, n′ from the pressure drop and flow rate along the rheometer pipe, calculating a shear rate from n′ and the flow rate, and obtaining the rheogram of the fluid as a relation of shear stress versus shear rate.

### BRIEF DESCRIPTION OF THE FIGURES

FIG. 1 describes some rheological models which may apply to some liquids used in oil and gas, such as drilling muds, cement sully, brines, frac gel, proppant loaded frac gel, etc. according to the prior art.

FIG. 2 shows a velocity profile of a liquid flowing through a pipe having a length L, a diameter D, and a flow q for different type of fluid rheological models, according to the prior art.

FIG. 3 describes the flow condition along a pipe for various type of fluid according to the prior art, according to the prior art.

FIG. 4 shows a graph of a coefficient, n′, that is used in calculations according to the present disclosure, according to the prior art.

FIG. 5 is an illustration of a series of plots, each representing a calculation to be performed, according to the prior art.

FIG. 6 is a schematic illustration of a rheometer system for measuring the rheology of drilling mud according to embodiments of the present disclosure.

FIG. 7 is an illustration of other embodiments of a pipe rheometer according to embodiments of the present disclosure.

FIG. 8 shows yet another embodiment of the present disclosure in which the measurement pipe may be coupled rigidly to the rheometer reservoir according to embodiments of the present disclosure.

FIGS. 9a-9d together depict embodiments of a pipe discharge according to embodiments of the present disclosure.

FIGS. 10a-10c are plots used in the rheology calculations according to embodiments of the present disclosure.

FIG. 11 covers the steps involved between the level and weight measurement to the determination of the rheogram.

FIGS. 12a-12d is a flow chart diagram showing a method in accordance with an embodiment of the present disclosure.

FIG. 13 is a cross-sectional schematic view of a filter for use with the pipe rheometer according to embodiments of the present disclosure.

FIG. 14 is a cross-sectional and perspective view of a base pipe and trapezoidal wires according to embodiments of the filter for the present disclosure.

FIG. 15 shows an embodiment of the rheometer reservoir to mitigate sedimentation in the reservoir according to embodiments of the present disclosure.

FIG. 16 shows features of a reservoir according to embodiments of the present disclosure which allow forced cleaning between different phases of filling of the rheometer reservoir.

FIG. 17 is a cross-sectional schematic view of a reservoir according to further embodiments of the present disclosure to avoid sedimentation and gelling in the reservoir

FIG. 18 includes schematic views of yet other configurations for the pipe of the rheometer according to embodiments of the present disclosure.

FIG. 19 is a cross-sectional schematic view of a pipe rheometer including a heating jacket according to embodiments of the present disclosure.

FIG. 20 shows the effect of the shape of the reservoir on the drainage process for the reservoir.

FIG. 21 is a cross-sectional schematic view of a pipe rheometer according to embodiments of the present disclosure.

FIG. 22 shows four steps to determine the gel of the liquid according to embodiments of the present disclosure.

FIG. 23 is a graph representing the measurements performed by sensors during the gel acquisition sequence described in FIG. 23 according to embodiments of the present disclosure.

FIG. 24 shows a flow chart diagram of a method of confirming that the flow within a measurement pipe is laminar according to embodiments of the present disclosure.

FIG. 25 shows yet another flow chart diagram of a method for determining entry length for the measurement pipe according to embodiments of the present disclosure.

FIG. 26 is a block diagram of an operating environment for implementations of computer-implemented methods according to embodiments of the present disclosure.

### DETAILED DESCRIPTION

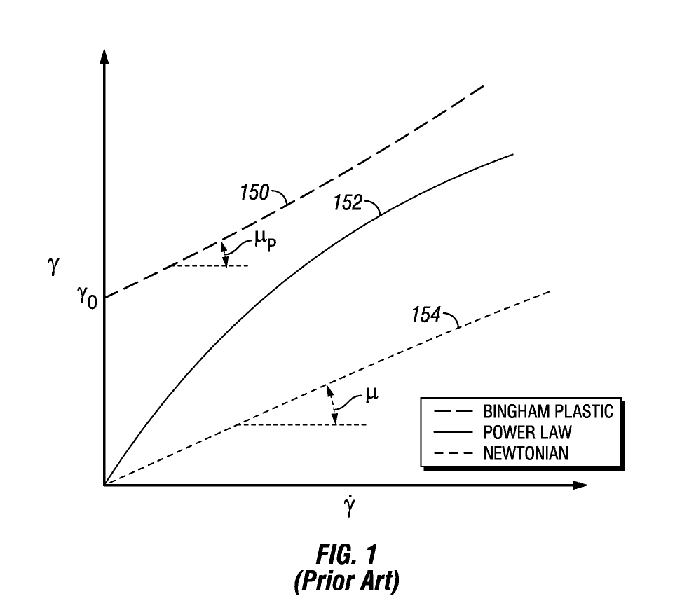

The following is a detailed description of embodiments of the present disclosure with reference to the figures. The following description relates to the measurement of the rheological behavior of liquid. FIG. 1 describes some rheological models which may apply to some liquids used in oil and gas, such as drilling muds, cement sully, brines, frac gel, proppant loaded frac gel, etc. according to the prior art. FIG. 1 is a plot of shear stress γ against shear stress, τ and shows plots for Bingham plastic 150, power law 152, and Newtonian 154. The equations for these fluids are as follows:

τ=μγ Newtonian Fluid Model:

τ=τₒ+μₚγ Bingham Plastic Model:

τ=kγⁿ Power Law Model:

Drilling mud may often be characterized as “Bingham plastic fluid”; however, some oil based mud (“OBM”) or polymer mud may be better described as power law fluid. Brines are often Newtonian fluids. Unloaded frac fluids are commonly described as power law fluids.

Cement slurry may display various rheological behavior depending on the chemical composition. The instrument described in the present disclosure and associated with the described operating procedures can allow the determination of the rheological of these types of fluids. A few final steps of the processing sequences can advantageously be adapted to the specific rheological model.

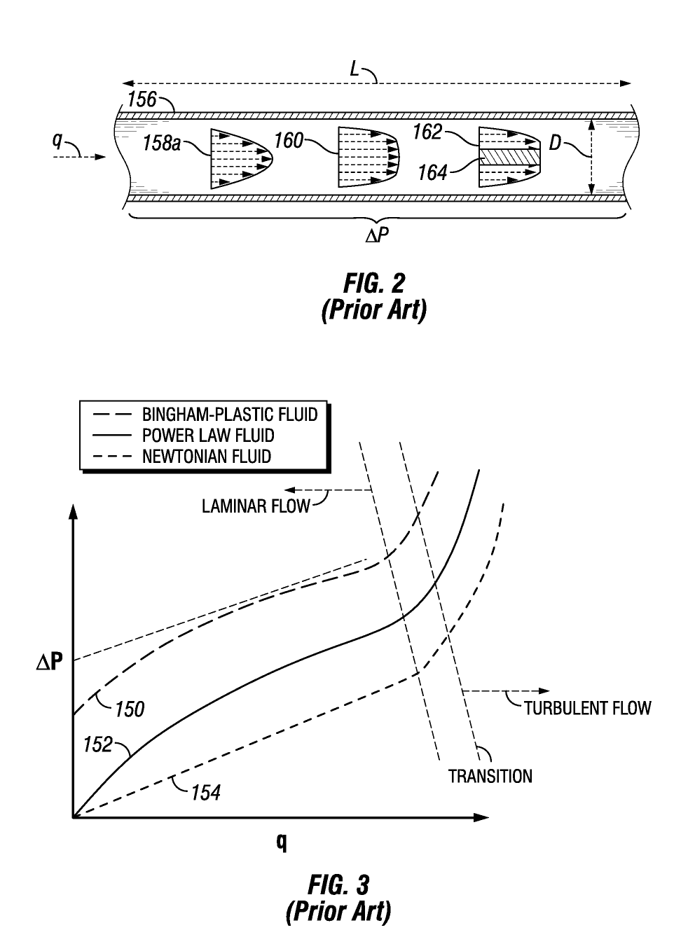

FIG. 2 shows a velocity profile of a liquid flowing through a pipe 156 having a length L, a diameter D, and a flow q. FIG. 2 shows laminar flow which depends on the rheological behavior according to the prior art. There is a Newtonian Fluid profile 158, a Power Law Fluid profile 160 with n<1, and a Bingham-Plastic Fluid profile 162 which has a plug flow in center 164. The shear rate at the wall (which is the gradient of the velocity versus the radius) is sternly affected by the rheological model. The laminar flows can be fully described by an analytical formula, obtained by the conventional equation of fluid mechanics.

FIG. 3 describes the flow condition along a pipe for various type of fluid according to the prior art. There is a plot for the Bingham-Plastic Model 150, Power Law Model 152, and Newtonian Fluid Model 154, similar to what is shown in FIG. 1. The graph represents the relation of pressure drop, P versus flow rate, q. The part in laminar flow can be obtained by analytical solution of the fluid mechanics equation. However, at higher flow turbulence may occur and relations change and analytical formula no longer apply. The transition from laminar flow can be predicted as it depends on the rheological behavior of the liquid as well as the flow conditions: dimensionless number such as Reynolds number (Re) and Hedstrom number (He) allow are typically used to determine the flow regimes.

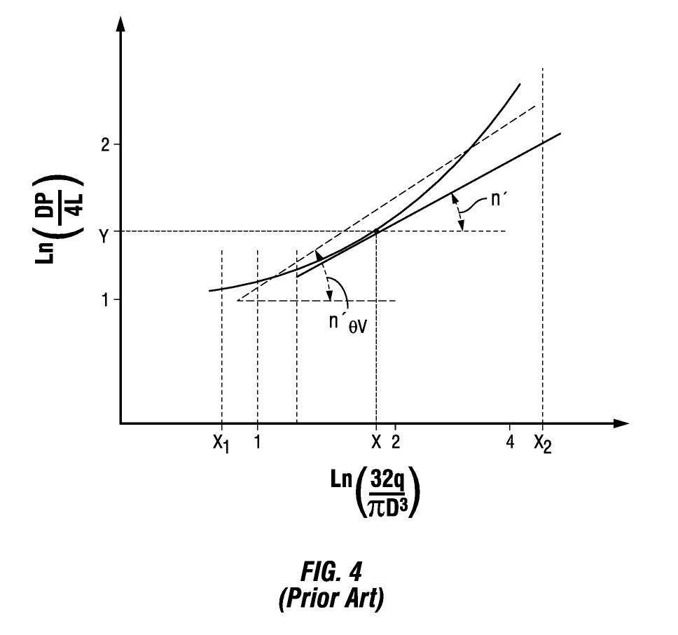

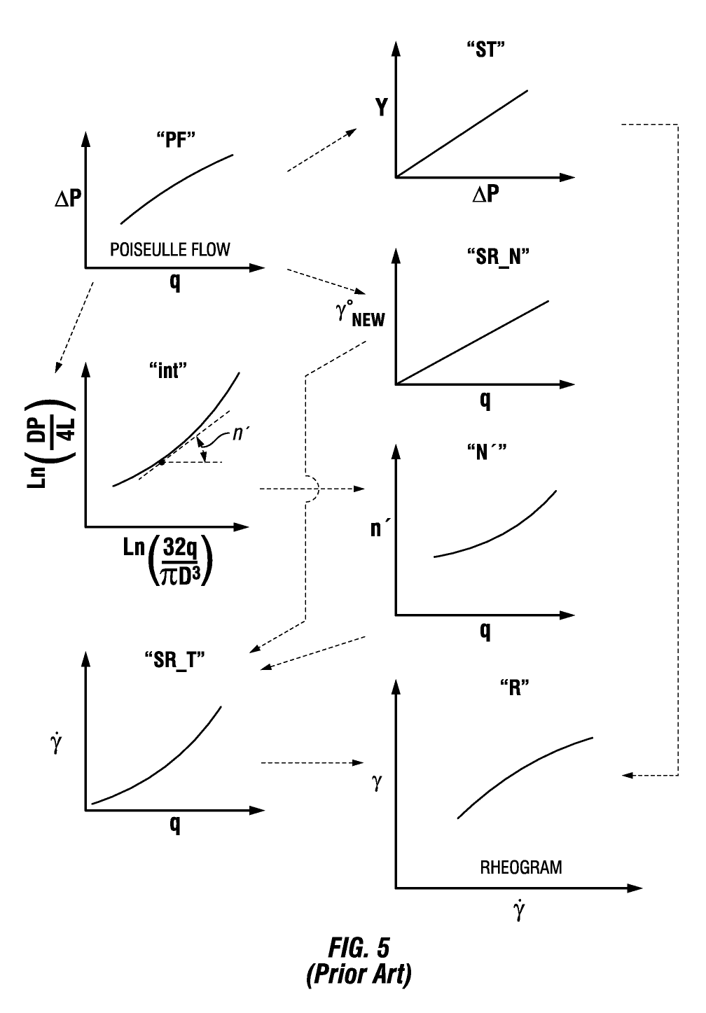

FIG. 4 shows a graph of a coefficient, n′, that is used in calculations according to the present disclosure. It should be noted that the rheological properties calculated by systems and methods of the present disclosure are based on the relation between shear stress and shear rate. For the pipe rheometer and other components of disclosed herein, the shear stress depends only on the pipe characteristic and the measured pressure drop. At the wall, the shear stress is determined as followed

$$τ = \frac{D P}{4 l}$$

The shear rate can also be determined, it determination needs an additional calculation step. One method is to generate the graph as shown in FIG. 4 when multiple flow conditions (flow rate and pressure) are known. Then for each point of this curve, the slope of the tangent to the curve can be determined: this slope is the coefficient n′ for that flow condition. This coefficient allows to correct the shear rate estimated for a Newtonian liquid according to embodiments of the present disclosure. The coefficient n′ is calculated according to the following equation:

$${n}^{′} = \frac{dln ( \frac{DP}{4 l} )}{dln ( \frac{32 Q}{π {D}^{3}} )}$$

$$With \text{:}$$

$$P \text{:} pressure drop along the pipe$$

$$Q flow rate$$

$$l \text{:} length of the measurement pipe , \\ D \text{:} internal diameter of the pipe$$

The non-Newtonian factor n′ being a dimensionless parameter. The coefficient n′ is a measure of how far the rheological properties depart from standard Newtonian fluid behavior, so that the shear rate at the wall needs to be corrected versus the shear rate at the wall for the similar flow of a Newtonian fluid

$$γ = corr {γ}_{New}$$

$$With \text{:}$$

$${γ}_{new} = \frac{4 Q}{π {R}^{3}} \text{:} the shear rate at the wall for a Newtonian fluid$$

$$γ \text{:} the shear arte at the wall for the none \text{-} Newtonian fluid$$

$$corr = \frac{( 1 + 3 n ′ )}{4 n ′} \text{:} the correction factor for shear rate .$$

The use of this coefficient is described below in connection with other components and methods of the present disclosure.

FIG. 5 is an illustration based on a series of plots, each representing the output of mathematical processing s to be performed that shows the steps to pass from the measurements performed with the pipe rheometer (which provides delta-pressure versus flow rate) to the rheogram which relates the shear stress versus shear rate. From the measurements of the graph “PF” (“Poiseulle Flow”), three processing paths are taken to determine the needed information's to determine the rheogram:

1) From the initial “PF” graph, the shear stress t is determined versus P as displayed in graph “ST” (“Stress”).

2) From the graph “PF”, the “Newtonian” shear rate is determined versus flow-rate and displayed in graph “SR_N” (“Shear-Rate Newtonian fluid”), using the theoretical relation of shear rate to flow rate for a given pipe when considering the flow of a Newtonian fluid. From the graph “PF”, the graph “int” (intermediate graph) is determined by converting the initial “PF” graph into dedicated log scales.

3) From the graph “int”, the slope of the tangent to the curve for several flow rate is determined. That slope is the value of n′ corresponding to that flowrate. The multiple values of n′ are ported into the graph “N′”.

Then, the graph “SR_T” (Shear-Rate True for this None-Newtonian fluid) is constructed by plotting the corrected shear rate versus the corresponding flow rate. The corrected shear-rate is obtained as: γ=n′ γNew

Then the graph “R” (rheogram) is prepared form the multiple (K) pairs of data (γ, τ) corresponding to K pairs of measurements (ΔP, Q). For each pair, γ is obtained from the graph “SR_T” for the given Q; and t from the graph “ST” for the given. These K pairs (γ, τ) provide the rheogram “R”. This experimental rheogram is used to fit the best rheological model (described in FIG. 1).

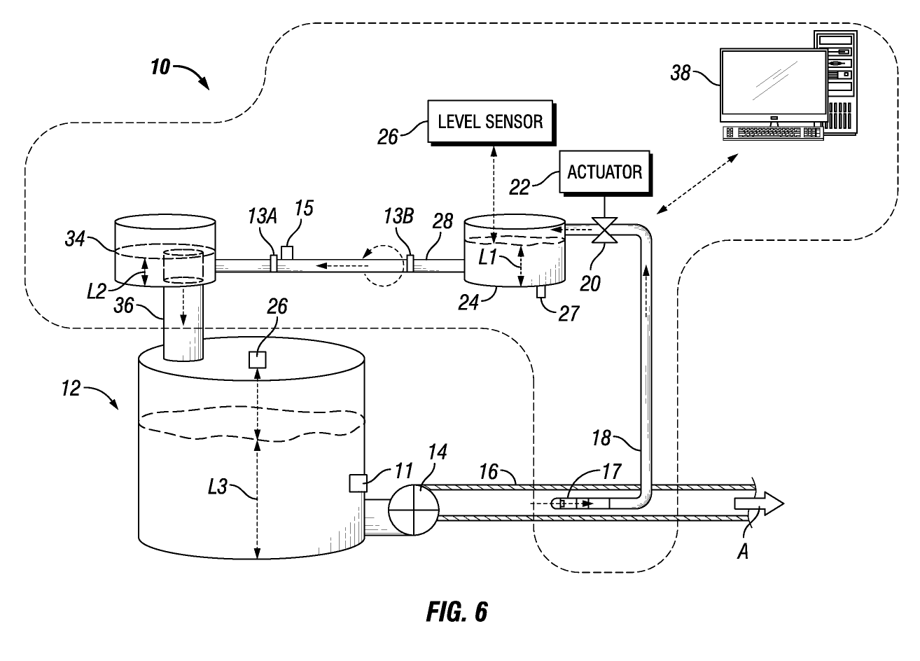

FIG. 6 is a schematic illustration of a rheometer system 10 for measuring the rheology of drilling mud according to embodiments of the present disclosure. As will be described below, the system 10 allows the determination of the rheological properties of the process liquids. It is to be understood that there are other methods and devices which are capable of calculating viscosity and/or rheology of the process liquid, and that the systems and methods of the present disclosure achieve the similar process to without the use of expensive, labor intensive, and/or delicate measuring devices of the prior art.

The system 10 can be used for measuring rheology of various types of liquids, including Newtonian liquids and non-Newtonian liquids. For purposes of brevity and illustration, the present disclosure is described as measuring and handling liquid. The liquids can be a drilling fluid including various additives. These additives may be weighting agent (IE Barite), loss-circulation materiel (LCM) and Well-strengthening-materials (WSM) which may be available as large solid or flakes, gelling component (IE bentonite), dispersant (IE ligno-sulfonate). Other additives may be also present but may have fewer effects on the measurement process of rheology. As effect on the rheology measurement process:
Barite may separate from the liquid phase and create cake at the bottom of the rheometer reservoir 24 and the pipe 28 of the rheometer. Barite may also sag at the bottom of the rheometer pipe 28 during the measurement phase.
LCM and WSM have tendency to plug small openings with risk to clog the rheometer (such as the rheometer pipe 28).
Gelling agents modifies the rheological behavior of the liquid and may also create gels and thixotropic behavior.
Dispersants are used to typically reduce the viscosity of drilling fluids.

The system 10 is associated with a tank 12 which holds the mud. The tank 12 holds a major part of the liquid available at the operation site; the tank 12 may be part of the mud tank system of a drilling rig which circulates the mud downhole during a drilling operation. The discharge of tank 12 may be performed by a pump 14 configured to conduct liquid from the tank 12 through a pipe 16. The tank 12, the pump 14 and the pipe 16 can be part of the drilling rig component or another installation for which the liquid (i.e. mud) is being used during normal operation. In some embodiments the majority of the liquid follows the path of the arrow A which can lead to a triplex pump of the installation (i.e. the drilling rig) and to the remainder of an operation performed by the installation. The installation may be a drilling rig which may perform various operations involving different liquids, including the following non-exclusive list:
Drilling process with drilling mud;
Cementing process involving chemical wash, spacer liquid, and cement slurry;
Circulation of brine in the well;
Placement of chemical pills, such as acidizing; or
Any other process performed by the drilling rig.

The installation may also be a frac fleet involving frac mixers of gels and proppant. The installation may also be a coiled-tubing unit or work-over rig operating within a well and involving the pumping of various liquids in the well.

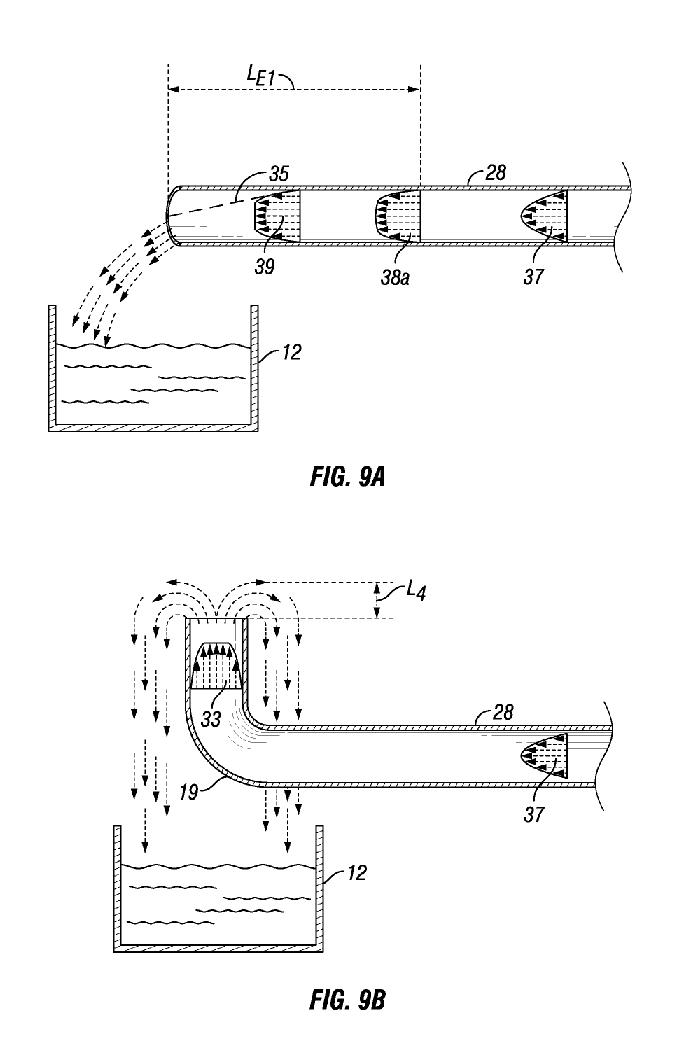

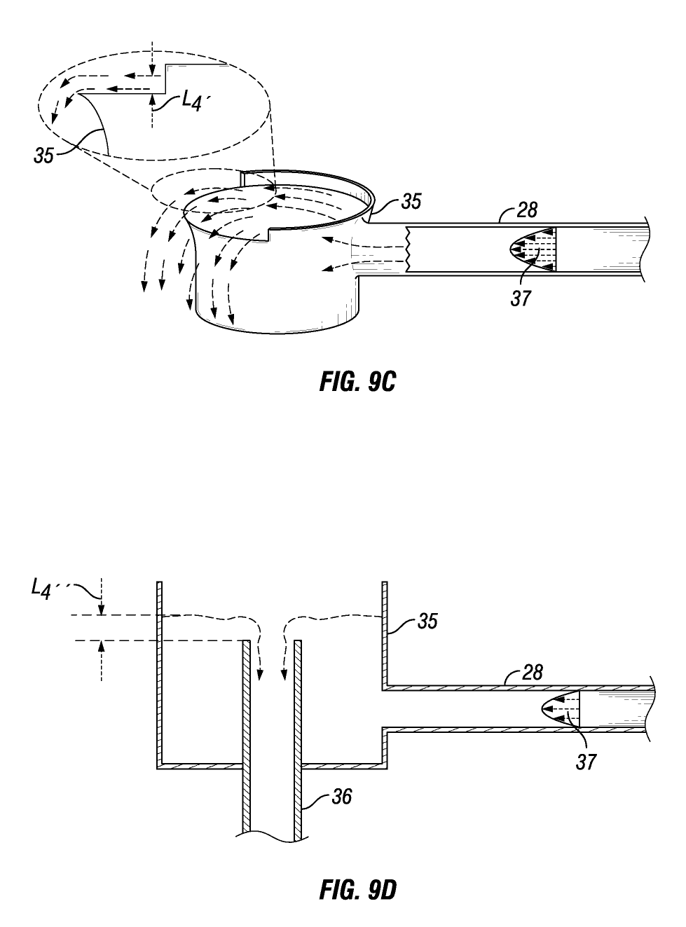

The system 10 includes a diverter circuit 18 which is fluidly coupled within the pipe 16 such that the diverter circuit 18 can divert some of the mud out of the pipe 16. The remainder of the liquid which does not enter the diverter circuit 18 can circulate through another circuit, such as shown by arrow A or even returned to the tank 12. Depending on the embodiment, the diverter circuit 18 can take a sample of the liquid from different point in the main liquid loop at various times selected by the control system 38. For example, in some embodiments several diverter circuits 18 and valves 20 may be present to ensure sampling of the liquid form various rig areas, possibly involving multiple rig pipes 16. In some prior art mud monitoring operations, the mud is taken manually. From time to time an operator would go to the mud holding tank (i.e. tank 12) with a pitcher in hand, scoop out a pitcher full of mud, and deposit the mud into the rheology measurement apparatus (i.e. the API recommended devises such as FANN 35 or a Marsh funnel). The systems and methods of the present disclosure enable more frequent samples, automated samples, and more-representative samples which can be taken from a hard-to-reach area of the mud loop, yielding more true results. The system 10 also include a filter 17 at the connection with the main pipe 16 that is described in detail with respect to FIG. 9 below. The filter may ensure that large elements flowing with the mud inside the pipe 16 may not enter in the rheometer diverter circuit 18.

The system 10 also includes a valve 20 in the diverter circuit 18, and an actuator 22 configured to operate the valve 20 to selectively permit the liquid to pass through the valve 20. The valve 20 permits the liquid to enter a rheometer reservoir 24. In some embodiments the rheometer reservoir 24 is substantially smaller than the tank 12 and serves to hold a sample of the mud. The relative size of the reservoir 24 can be chosen according to the needs of a given application. In some embodiment, the rheometer reservoir 24 may be from 1 to 4 quarts, or even from 1 to 10 gallons or any other suitable size.

The rheometer reservoir 24 is equipped with certain components which allow measurements to be taken on the liquid within the rheometer reservoir 24. The rheometer reservoir 24 can include a level sensor 26 which can determine the level of the mud within the rheometer reservoir 24 at any given time. The level measurement may be obtained with accurate reference of the time of the measurement which allows obtaining a proper relation of the level in the rheometer reservoir 24 versus time. The level sensor 26 can be a pulsed radar sensor, a pulse-echo ultra-sonic sensor, an optical sensor, a capacitive sensor, or any other suitable level sensor. In another embodiment, another sensor 27 may be installed at the rheometer reservoir 24 to determine the weight of the reservoir. In another embodiment, the sensor 27 may provide the hydrostatic pressure of the liquid in the rheometer reservoir 24. In another embodiment, a load cell (represented by 27 in FIG. 6) allows to determine the weight the liquid within the rheometer reservoir 24, subtracting the weight of the empty reservoir from the total weight measurement. With the geometrical description of the rheometer reservoir 24 associated with the measurement of weight of the fluid in the rheometer reservoir 24, and the liquid level obtained by the sensor 26 in the rheometer reservoir 24, the density of the liquid in the reservoir may be determined.

The density p can be calculated simply by the well-known relationship of mass and volume:

ρ=m/v

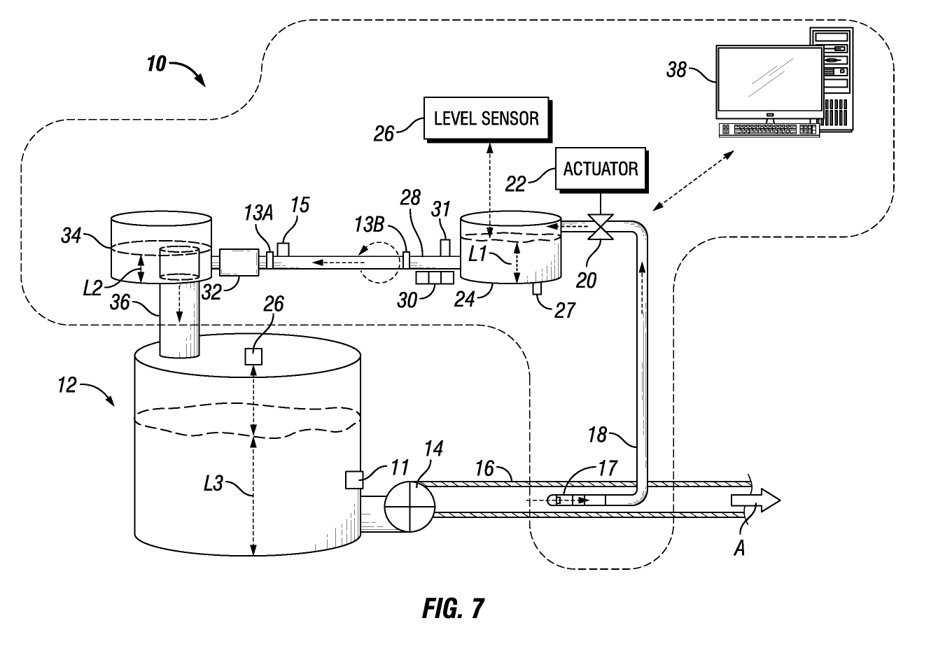

FIG. 7 is an illustration of other embodiments of a pipe rheometer 10 according to embodiments of the present disclosure. The pipe rheometer 10 includes a sensor 30 that can be configured to calculate the liquid density in the rheometer reservoir 24. The sensor 30 can be placed in the rheometer reservoir 24 or along the diverter circuit 18 as is shown in FIG. 7. The sensor 30 can be a density vibrating sensor, an x-ray or y-ray source and detector to measure the attenuation for rays passing through some liquid.

The rheometer 10 can also include a sensor 27 at the rheometer reservoir 24 that is allowed to move vertically freely to associate vertical movement of the rheometer reservoir 24 with weight onto the sensor 27. The sensor 27 can be a load cell or weight scale.

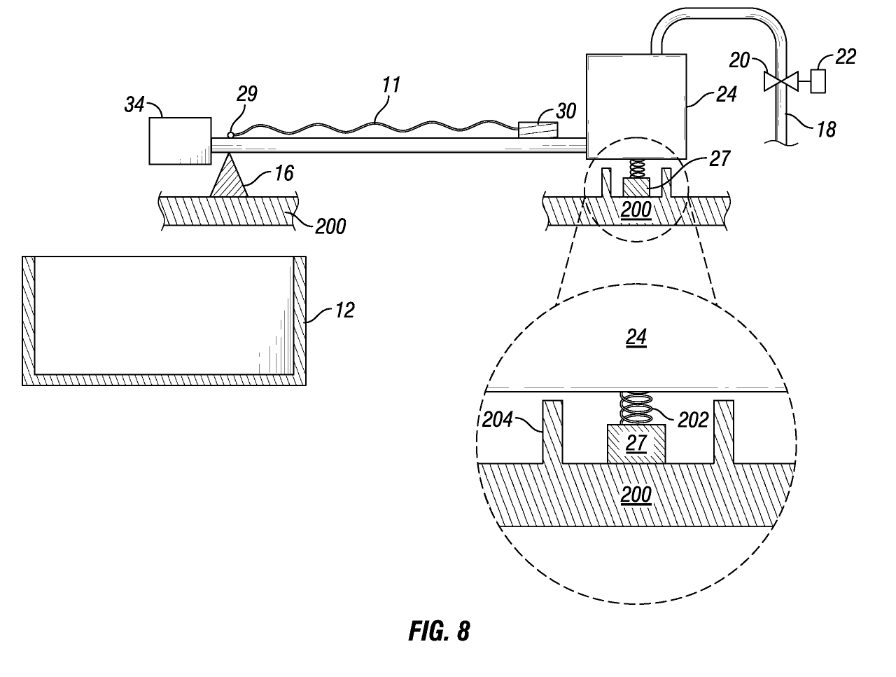

FIG. 8 shows yet another embodiment of the present disclosure in which the measurement pipe 28 may be coupled rigidly to the rheometer reservoir 24. The reservoir assembly 24 may pivot over a hinge 16, allowing proper weight measurement by the sensor 27. Provided the sensor 27 is protected from overload, the sensor 27, which may be a weight or load cell sensor, can give an accurate reading of the weight of the liquid in the reservoir 24 by subtracting the weight of the empty, unladen unit. The measurement pipe 28 can be coupled at a distal end to a rheometer tank 34 into which the liquid is delivered after passing through the measurement pipe 28. The sensor 27 can be connected to the rheometer tank 24 via a spring 202 which can transmit the weight (or force) to the sensor 27. However this spring 202 is deformed with the load. When the load reaches a certain limit, the spring deformation allows the rheometer reservoir 24 to contact directly the stop 204 connected directly to the system chassis 200. This acts as overload protection so that the sensor 27 is not damaged by too high a load.

FIGS. 9a-9d together depict different liquid exit ports from the rheometer pipe 28 according to embodiments of the present disclosure. FIG. 9a is an embodiment with the straight end of the pipe 28 allowing the liquid exiting the measurement pipe 28 to fall into the tank 12. With such design, particles may not accumulate within the measurement pipe 28 However, a certain length of the pipe LE1 may be filled only partially inducing perturbation in the liquid velocity profile along this pipe length LE1 and the calculations will need to be updated to take this into account.

FIG. 9b is directed to embodiments in which the exit port from the rheometer pipe includes an elbow 19, so that rheometer pipe 28 stays full over the whole length. However the velocity profile 33 maybe deformed due to the flow in the elbow so that some small additional pressure drop is generated. Such effect may be added to the “entry length” effect, which is described later. Also, the reference level for the head determination (or the delta pressure) is not the edge of the elbow 19, but may be estimated as the top of the liquid surge, which corresponds to a levitation L4 above the edge of the elbow 19. Such levitation L4 may be determined by using the total energy of the flow which is described in detail below.

FIG. 9c is directed to embodiments including a temporary tank 35. The liquid escapes from this temporary tank 35 to fall into the main tank 12 via an elongated lip which covers a fair part of the periphery of the temporary tank 35. Thanks to this elongated lip, the variation of level L4′ is quite limited. This may not require any head correction, but such a design may need some additional cleaning to avoid accumulation of particles in the temporary tank 35.

FIG. 9d is directed to yet another embodiment in which a temporary tank 35 has an interior drain pipe 36. The level difference L4′ may be present above the edge of the drain pipe 36. This level difference L4′ may either be ignored in the head or it may be estimated by a model of flow around such edge: however this model may needs an estimate of flow rate and rheology; so that iterative process for solving the problem may be needed.

Referring back now to FIGS. 6 and 7 together, the rheometer reservoir 24 is connected to the measurement pipe 28. A portion of the liquid from the reservoir 24 is directed out of the reservoir 24 through the measurement pipe 28. The measurement cycle for the rheology determination is performed under the control of the computer 38. Based on the output of the level sensor 26, the computer 38 determines that the liquid level in the rheometer reservoir 24 is below the maximum filling level and, in response, opens the valve 20 by sending a signal to the actuator 22, allowing the filling of the rheometer reservoir 24 via the diverter pipe 18. The computer 38 continuously monitors the liquid level in the reservoir 24 via the output of the level sensor 26. When the level reached the threshold of maximum filling, the computer 38 closes the valve 20 via the actuator 22. Then, the stored reservoir liquid is drained out of the rheometer reservoir 24 through the measurement pipe 28. This drainage phase is the measurement phase. During the drainage phase, the liquid level in reservoir is continuously reducing and is continuously measured by the level sensor 26 which feeds this measurement to the computer 38, yielding L(t) which is liquid level over time.

The computer 38 also knows the geometry of the rheometer reservoir 24. For every measurement of liquid level by the sensor 26, the computer 38 can determine the liquid volume inside the rheometer reservoir 24 according to the following equation:

Vol(t)=Funt[L(t)]

In one example for a reservoir with an uniform cross-section:

Vol(t)=SL(t)

With: S=horizontal section of the reservoir. This allows the computer 38 to determine the volume of liquid in reservoir 24 versus time.

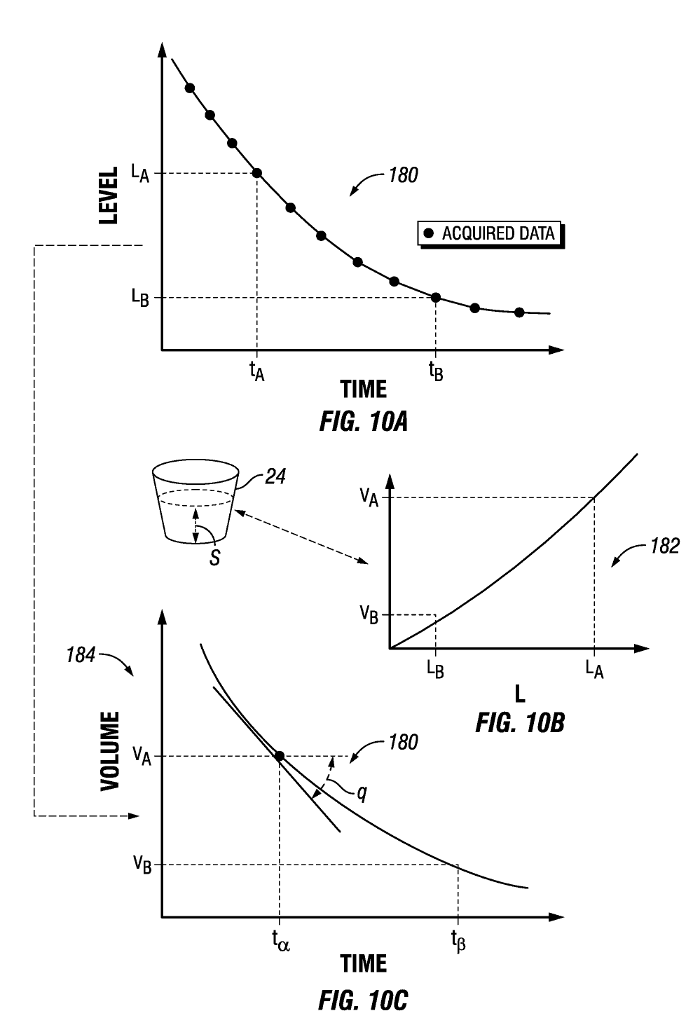

FIGS. 10a-10c are plots used in the rheology calculations according to embodiments of the present disclosure. FIG. 10a is a plot 180 of level over time. This is the output of the level sensor 26 versus time during the drainage phase. FIG. 10b is a plot 182 describing the volume of the reservoir 24 versus level within that reservoir. This plot 182 is the geometrical description of the reservoir based on it geometrical design. FIG. 10c is a plot 184 of volume over time. This plot 184 is obtained by combining the information of the graph 10a and 10b. It determines the fluid volume left in the rheometer reservoir 24 for any elapsed time of the drainage phase. For example, at time tₐ, the reminding volume is Vₐ, while at time t_{b} the remaining volume is Vb. From the graph 184, the flow-rate Q at a defined drainage time is the slope of the tangent to the curve.

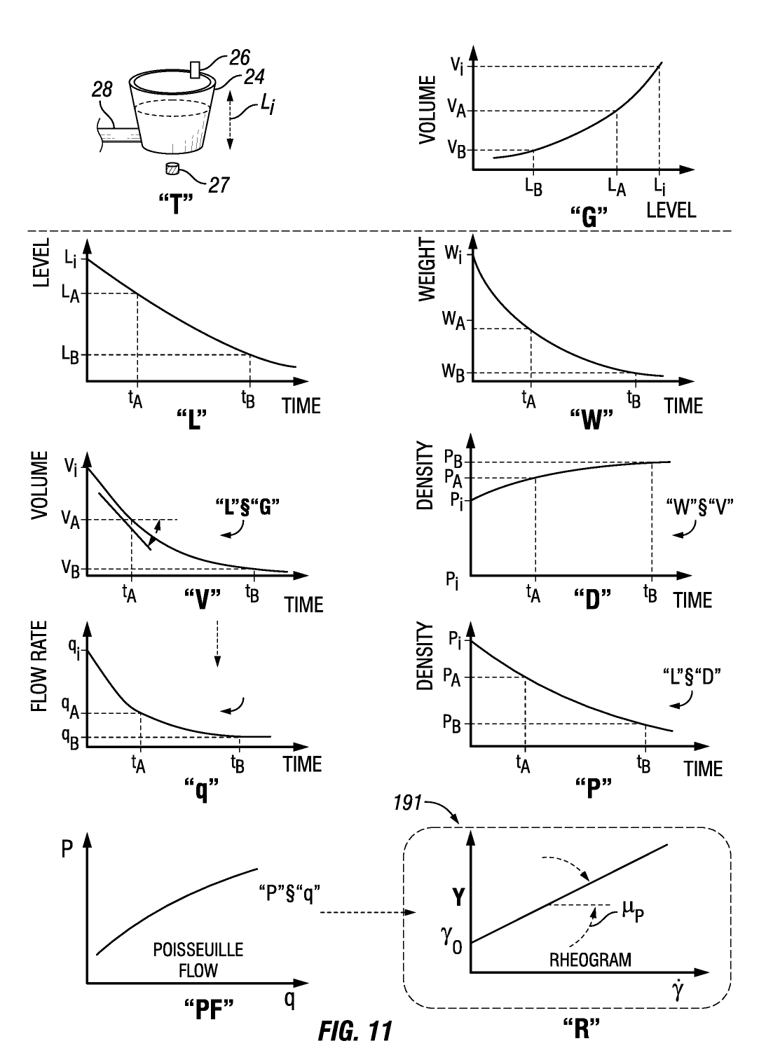

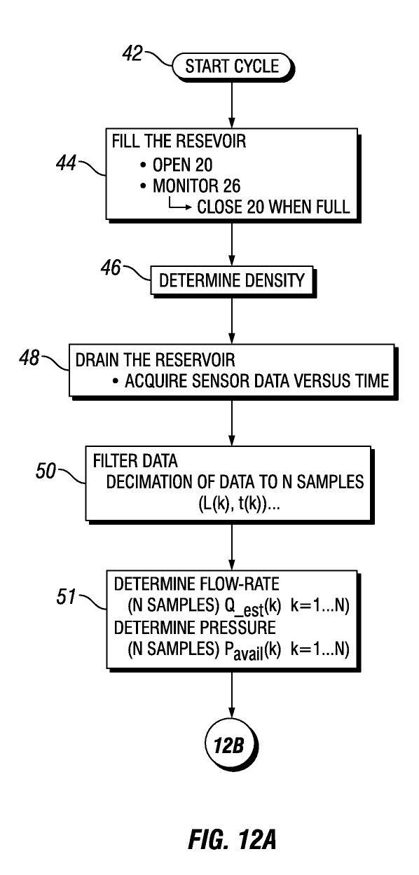

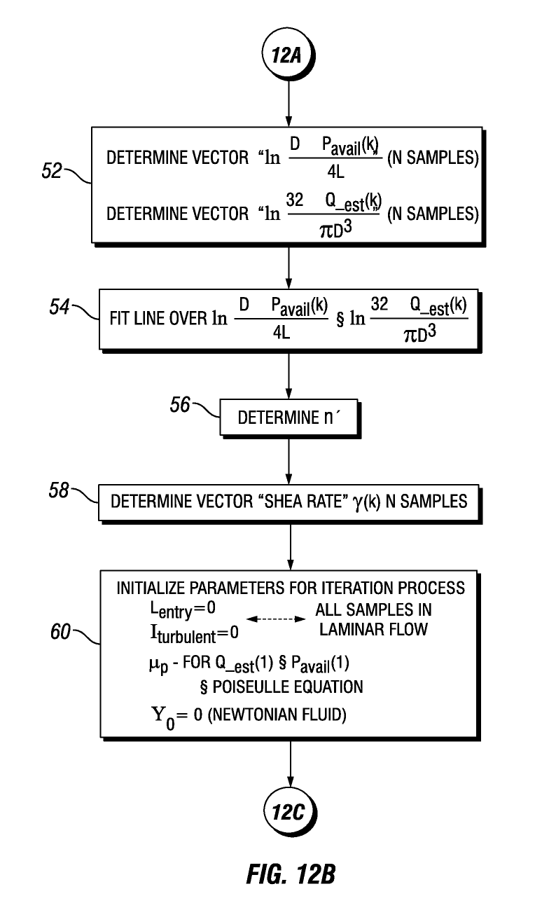

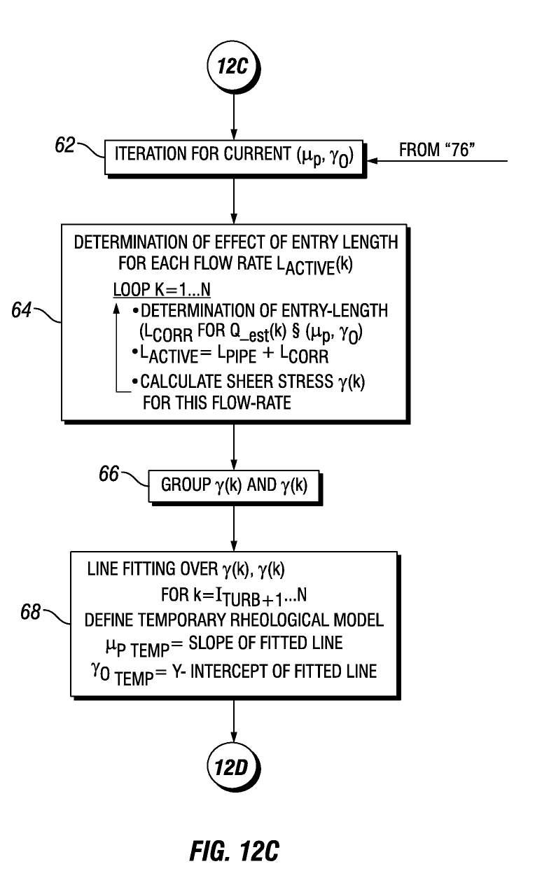

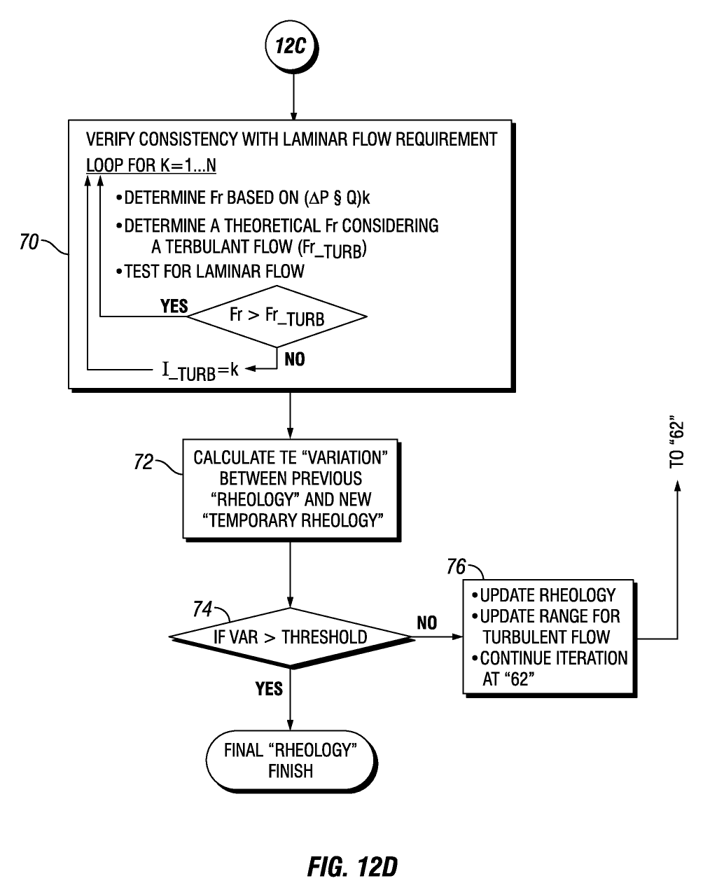

FIG. 11 covers the steps involved between the level and weight measurement to the determination of the rheogram. FIG. 11 shows graphs T, G, L, W, V, D, p, P, PF, and the final rheogram 191. The computer knows the geometry of the rheometer reservoir 24, defined as graph “T” of FIG. 11. It can relate the liquid level to its corresponding volume (graph “G”) remaining in the rheometer reservoir 24: the same graph is displayed in FIG. 12b. During the drainage phase, the level is continuously monitored (graph “L”) via the sensor 26, as well as the weight of the liquid via the sensor 27 (graph “W”). From the level measurement (graph “L”) and the knowledge of the reservoir geometry (Graph “G”), the computer 38 can determine the liquid volume in the rheometer reservoir 24 versus time (Graph “V”). Then the computer 38 can determine the flow rate (Graph “Q”) as derivation of the volume versus time using the following equation:

$$Q ( t ) = \frac{δ Vol ( t )}{δ t}$$

In the case of a rectangular reservoir where S is the horizontal section of the reservoir:

$$Q ( t ) = S \frac{δ L ( t )}{δ t}$$

Using the weight measurement (Graph “W”) associated with the liquid volume (Graph “V”), the computer 38 can determine the liquid density versus drainage time (Graph “D”). The liquid density may vary during the drainage period, as the liquid may not be homogenous and may separate due to sediment or other factors.

Furthermore, the computer 38 may combine the density information from the graph “D” with the level information (graph “L”) to determine the hydrostatic pressure in the rheometer tank (shown in graph “P”). Finally, the computer may group the flow rate (graph “Q”) and the pressure (graph “P”) to create the flow characteristic through the measurement pipe (graph “PF”) which is known as “Poisseule” flow relation through a tube. From this graph “PF”, the computer 38 may determine the rheogram “R” 191.

The measurement pipe 28 leads into an exit port to return the liquid to the tank 12. Three types of exiting port may be used:
a) A simple straight pipe extremity as shown in FIGS. 11a and 11b: the liquid falls from the measurement pipe 28 into the tank 12 by a parabolic trajectory. With such a design, there is no risk of particles accumulating at the pipe exit. But the pipe 28 may not be filled properly over the whole length, especially near the exit. The calculations can be adjusted to account for this.
b) Elbow towards the top at the extremity of the measurement pipe 28 as shown in FIGS. 11c and 11d. The exiting liquid is jetted slightly above the horizontal physical edge of the pipe 28. The presence of the elbow 19 introduces some small additional pressure drop which may have to be estimated. Typically this is taken into account by adding some perturbation length at the physical length of the measurement pipe 28. The jetting effect at the exit can be easily corrected as explained below.
c) A small tank (called temporary tank) 35. The liquid is accumulated shortly in the temporary tank 35. The liquid can flow out of the tank 35 either through a return line 36 which preferably penetrates into the tank 35, or by an over-flow edge (line) at the periphery of the tank 35.

In each case, the exit edge (top of the penetrating return-line or the over-flow edge) is preferably above the level of the measurement pipe 28. With some design of this tank 35, a method to remove sedimentation form the small tank may be added.

It should be noted that the 90 degree elbow 19 may be terminated by widening of its internal section (such a cone). In this case, this extension may be considered as a small temporary tank fed by the bottom and with an over-flow edge covering a 360 degree azimuth.

The determination of rheological model requires also the determination of pressure drop ΔP through the measurement pipe 28. The pressure drop ΔP can determined by the difference of liquid level between the rheometer reservoir 24 and the level of the liquid at the exit. The liquid level at the exit may be considered as followed:
With straight extremity of the measurement pipe, this is the center of the measurement pipe 28;
With a measurement pipe terminated by a 90 degree elbow, the exit level is the level of this flat surface of the elbow; and
With a temporary tank, the exit level is defined by the level of the ridge corresponding to the escape line of the fluid. This can be the level of the return line 36 if used in this temporary tank, or the overflow line of the other temporary tank design.

Based on this determination of the exit level, AP within the measurement pipe 28 is the difference of level between the liquid in rheometer reservoir 24 and the exit level is:

=L_{meas exit}

With: Lₘₑₐₛ: the measurement of level provided by the level sensor 26;
hₑₓᵢₜ: the height of the exit from the temporary tank 34;
h: the effective head forcing the fluid into the measurement pipe 28.
Then, the ΔP can be calculated using the following equation:

P=μg

Where P is the pressure, ρ is the density, g is the gravitational constant. The factors ρ and g are constants, so P is a linear function of h, the level of the mud within the rheometer reservoir 24.

When considering the Bernoulli relation (total energy equation for fluid and liquid), it should be noted that the kinetic energy may have to be considered. For the supply side at the rheometer reservoir 24, the surface of that tank is large so the kinetic energy of fluid moving downwards in the reservoir 24 is small and often negligible. At the exit of the measurement pipe 28 with exit “c”, the kinetic energy may be negligible. With exit type “a” or narrow “b”, the kinetic energy may be included to calculate the effective delta pressure for the calculation of the rheological behavior of the liquid:

Corr_{ΔP}=½ρV²=½ρQ²

With Q: flow rate;
Corr_{ΔP}:correction for ΔP
And P_{corr}=P−Corr_{ΔP}

In case of large exit system (such as system “c”), CorrΔP=0 and Pcorr=P. The interior dimensions and diameter of the measurement pipe 28 are known. The flow rate of the mud through the measurement pipe 28 can be calculated using the level sensor 26. It is safe to assume that all the mud enters the measurement pipe 28. The dimensions of the rheometer reservoir 24 make this a simple calculation. The flow rate is represented by the variable Q. As the pressure drop is measured while the liquid flows through the measurement pipe 28, a shear stress at the wall of the measurement pipe can be calculated from the equation:

$$τ = \frac{R {P}_{corr}}{2 l}$$

Where τ is the shear stress, R is the interior dimension of the measurement pipe 28, I is the length of the measurement pipe 28. The interior dimension can be an interior radius in the case of a cylindrical measurement pipe 28. Other shapes for the measurement pipe are possible, including a square profile, an elliptical profile, or another suitable shape. The equations for shear stress for these profiles are known in the art.

In a Newtonian fluid, the relation between the shear stress and the shear rate is linear, passing through the origin, the constant of proportionality being the coefficient of viscosity. In a non-Newtonian fluid, the relation between the shear stress and the shear rate is different and can even be time-dependent (Time Dependent Viscosity). Therefore, a constant coefficient of viscosity cannot be defined. The rheological graph sought after by the systems and methods of the present disclosure are a plot of shear stress and shear rate. (Shear strain and shear rate are synonymous for purposes of the present disclosure.) Many muds are non-Newtonian and therefore the rheological graph must be calculated to properly understand the properties of the mud.

For non-Newtonian fluids, there is a factor referred to as n′ which is a measure of how far from Newtonian a given non-Newtonian fluid behaves. To calculate n′, the following equation can be used:

$${n}^{′} = \frac{dln ( \frac{R Pcorr}{2 l} )}{dln ( \frac{4 Q}{π {R}^{3}} )}$$

The non-Newtonian factor n′ is a dimensionless parameter, P_{corr} is pressure drop, I is length of the measurement pipe 28, Q is the flow rate, and R is the interior radius of the measurement pipe 28. As described above, all necessary variables to calculate n′ are available from the system 10 shown in FIG. 1, and without using an expensive, delicate, labor-intensive device such as a Fann 35.

Once n′ is known, the following equation can be used to calculate shear rate at the wall corresponding to a given flow rate is obtained by the following equation:

$$γ = \frac{( 1 + 3 {n}^{′} )}{4 {n}^{′}} \frac{4 Q}{π {R}^{3}}$$

For a Newtonian fluid, n′=1 and the term (1+3n′/4n′) is 1 and the n′ term has no effect. This allows to determine the pair of corresponding strain, τ, and shear ratey, for a given flow rate. When several pairs (τ, γ) corresponding to several flow rates have been obtained by using the rheometer 10 with a given liquid, the rheological graph is obtained by plotting the pairs of shear strain against shear rate. When the mud is non-Newtonian and n′ does not equal 1, then the rheological graph will be a curved graph. The degree of the curve depends upon the value of n′.

As the data samples are being taken when the rheometer reservoir 24 is drained, the P varies linearly as the level of liquid in the rheometer reservoir 24 decreases, but the level of liquid does vary with time as shown in FIG. 3A and depends on the shape of the rheometer reservoir 24 (FIG. 4B) as well as on the liquid rheology. The dependence of pressure with time is similar to the dependence of the level versus time. In one embodiment, the drainage process may be continuous. In such case, the level measurement performed by the sensor 26, as well as any additional measurements (as explained in FIG. 2) would be continuous. However, the acquired data by the computer 38 is digitized and correspond to specific time increment. First the ADC are insuring this conversion of the measurement into data series versus time increment. As ADC may be acquired at high rate, digital filtering and additional time decimation may be performed by the computer 38 to obtain a series of measurements which is limited in number of samples. This limited number of data samples may then be considered as the rheological data set for further processing.

In some embodiments such as shown in FIG. 7, more sensors may be added to improve some aspects of the process, including a flowmeter 32 along the measurement pipe 28 for a direct flow measurement. It can be a conventional flowmeter such as e-mag flowmeter or even a Coriolis mass-flow-meter. It can be useful to implement a full-bore flow measurement. The sensor 32 may also measurement the liquid density. A pressure gauge 31 may also be added along the measurement pipe 28. Ideally, this pressure gauge 31 should be installed after the length of pipe corresponding to the longest entry length.

If the flowmeter creates a pressure-drop (when not full-bore), it may be installed along the line but outside the length of pipe affecting the pressure measurement. In some embodiments it could be between the rheometer reservoir 24 and the pressure gauge 15.

A sensor array 30 can be used to determine the entry length and can be installed along the measurements pipe 28 (in the vicinity of the rheometer reservoir 24). Such sensing methods could be based on an array of sensors along the pipe 28 to perform the similar measurements and to determine when the steady flow condition is reached along the pipe 28. Such measurements method be hot film at the wall of the pipe, or ultrasonic Doppler probes or other suitable sensors.

In some embodiment, the system 10 can also include a computation component 38 which can be a computer such as a PC, or a controller or any other suitable form of computational unit. The computation component 38 can be coupled to the external controller (not shown), the level sensor 26, the weight sensor 27, and the actuator 22. It can also be coupled to additional optional sensors of the system such as the Coriolis sensor 32, pressure gauge 15 and sensor array 30. The computation component 38 may also be coupled to other devices external to the rheometer system 10, such as the pump 14 and other components of the system 10 and can be used to initiate a sample sequence by opening the valve 20 through the actuator 22. The computation component 38 can record data obtained by the various systems and can perform the calculations described herein to obtain the rheological plot for the fluid. The computation component 38 can also send transmissions with the data obtained by the system 10 to another site to allow an operator, such as a rig operator, to adjust some parameters of the drilling operation based in part upon the rheological plot.

FIGS. 12a-12d is a flow chart diagram showing a method 40 in accordance with an embodiment of the present disclosure. At 42 the method 40 can begin with a decision to begin a sample of the liquid. This can be initiated automatically by a controller, by a remote device, or according to a schedule. It can also be initiated manually. At 44 the reservoir is filled by taking some liquid from the main mud loop as shown in FIGS. 6 and 7 using the diverter circuit. The filling of the reservoir is stopped when enough liquid is added in the reservoir. This may be determined by the level in the reservoir and measured by the level sensor, or by the weight of the reservoir and measured by the weight sensor 27.

At 46 the density of the liquid (ρ_{liquid}) in the reservoir can be calculated in a variety of ways. One way is to know the geometry of the reservoir, the measured level of fluid in the reservoir and the weight measurement from the sensor 27, as well the weight of the empty reservoir. Another method to measure the density of the liquid by using a specific sensor such as Coriolis sensor which may optionally be installed along the measurement pipe 28. Another method is to obtain the density form a measurement performed by the density sensor 11 in the main tank 12. Yet another way to calculate density is by using a mud balance device.

At 48 the reservoir is drained by allowing the liquid to exit through a measurement pipe. In this step, as the liquid leaves the reservoir, the level of the liquid reduces and therefore the hydrostatic pressure in the tank reduces. This hydrostatic pressure allows to determine the pressure drop along the measurement pipe. This change of pressure also induces a reduction of flow rate versus the drainage time. During drainage, the sensors' data are acquired versus time, including the level of liquid in the rheometer tank is recorded. Data from other sensors such as an optional Coriolis sensor 32, pressure gauge 15 and sensor array 30 may also be recoded versus time during the drainage phase.

At 50, the measurements are digitally filtered and decimated to produce a series of digitized data versus time. This series of data may include level (from the level sensor 26). It may additionally include weight from sensor 27, flow rate (from Coriolis sensor 32), and/or density (from Coriolis sensor 32).

At 51, this provides vectors of N components such as:

$$For k = 1 to N$$

$$L ( k ) , t ( k )$$

$$Q est ( k )$$

$$Q\_ {}_{est} ( k ) = {Q}_{est ( k )} = \frac{{Q}_{est ( k - 1 )} - {Q}_{est ( k + 1 )}}{t ( k - 1 ) - t ( k + 1 )} = \frac{{L}_{( k - 1 )} - {L}_{( k + 1 )}}{t ( k - 1 ) - t ( k + 1 )} S ( k )$$

$${P}_{avail} ( k ) = {ρ}_{mud} g L ( k ) \frac{1}{2} ρ\_mud Q\_ext {( k )}^{2}$$

With
L(k): the vector of level data;
T(k): the vector of sampled time;
Q_est(k): the vector of estimated flow rate; and
L_{corr}: the vector of available pressure to generate flow drainage/in some case of using a pressure gauge 15.

Pₐᵥₐᵢₗ(k)=Pₛₑₙ(k)½ρ_mud Q_ext(k)²

### With

S(k): the vector of horizontal section of the rheometer tank 24 at level L(k)

g=9.81 M/s²

Potentially, other vectors may be prepared, such as:

Q_{cor}(k): the vector of flow rate from Coriolis sensor;
Pₛₑₙ(k): the vector of Pressure from pressure sensor; and
Dens_{cor}(k): the vector of density from Coriolis sensor.

At 52, the process to estimate n′ is performed. For each k index, a determination is made of:

$$ln ( \frac{D {P}_{avail} ( k )}{4 L} ) and ln ( \frac{32 Q\_est ( k )}{π {D}^{3}} )$$

At 54, a line is fitted over the N couples:

$$ln ( \frac{D {P}_{avail} ( k )}{4 L} ) and ln ( \frac{32 Q\_est ( k )}{π {D}^{3}} )$$

At 56, the slope of the fitted line is chosen as n′. At 58, the vector of shear rate is determined for each flow rate (N values) by using the following equation:

$$γ ( k ) = \frac{( 1 + 3 {n}^{′} )}{4 {n}^{′}} \frac{32 Q\_ext ( k )}{π {D}^{3}}$$

At 60, parameters for an iterative process are initialized, including:
L_{entry}=0 (No effect of entry length)
I_{turbulent}=0 (All measurements are estimated to be laminar flow)
μₚ=Estimated by the Poiseulle equation for Newtonian fluid, using Q_est(1), Pₐᵥₐᵢₗ(1), Lₚᵢₚₑ, and τ₀=0.
With:
L_{entry}: the entry length correction for entry and potential exit (such as elbow or exit into temporary tank 35 (if used) or partially empty pipe with extremity “a” (this could be a negative correction of length).
I_{turbulent}: the index in the vector of flow and pressure which corresponds to turbulent flow. It should be noted that the flow and pressure reduce with increased index.

At 62 the main iteration loop starts to determine a rheological model to the liquid behavior. At 64, a determination of the correction for the pipe length is made using the loop on k index for 1 to N, where: Lcorr is determined from μp and τ0 and Q_est(k), either based on Re conventional method or based on a table from CFD for various values of μp and τ0.

L_{active}=Lₚᵢₚₑ+L_{corr}

A determination of the shear stress corresponding to the N flow rate is calculated from the following equation:

$$τ ( k ) = \frac{D {P}_{corr} ( k )}{4 {l}_{corr}}$$

continued loop on k for a given set of values. At 66, regrouping of the rheological data in the vector of N components τ(k) and Y(k). A typical example is displayed in FIG. 4.

At 68, a straight line is fitted over the data set τ(k) and Y(k) having N−I turbulent components. The component corresponding between index 0 to (turbulent may be rejected. The slope of this line is the new plastic viscosity μ_{p temp} and the integration with the Y-axis is the yield value τ0_temp.

At 70, the method includes verifying consistency with laminar flow requirement. Using these values μ_{p temp} and τ_{p temp}, it is verified that each data pair is flowing in laminar flow. A loop on K for 1 to N is performed. For each k value, a friction factor may be determined using the following equations:

$${P}_{avail} ( k ) = 2 Fr ρ {V ( k )}^{2} \frac{L}{d} and V ( k ) = \frac{{Q}_{est ( k )}}{\frac{π}{4} {D}^{2}}$$

Regrouped, this provides:

$${P}_{avail} ( k ) = 2 Fr {ρ ( \frac{{Q}_{est ( k )}}{\frac{π}{4} {D}^{2}} )}^{2} \frac{L}{d} Or \frac{{P}_{avail} ( k )}{2 {ρ ( \frac{{Q}_{est ( k )}}{\frac{π}{4} {D}^{2}} )}^{2} \frac{L}{d}} = Fr ( k )$$

A Reynolds number is determined using the following equation:

$$Re ( k ) = \frac{{ρ}_{mud} V ( k ) D}{{μ}_{p \_ temp}}$$

It is verified that Fᵣ(k)>F_{r turb}Re(k). With F_{r turb} is obtained from some approximation of the fanning friction factor in turbulent versus Re. The Blasius approximation

$$[ Fr = \frac{0.0791}{Re} ]$$

may be used. And so: if

$${F}_{r} ( k ) > \frac{0.0791}{Re ( k )} ,$$

then the data set K is laminar. Else, the flow is turbulent and this data point must not be used for the determination of the rheological model: →turbulent=k

At 72, The variation between rheological parameters of this loop versus the previous loop is calculated using the following equation:

$$Var = 1 \text{/} 2 \sqrt{{[ \frac{2 ( μ {p}_{temp} - μ p )}{( μ {p}_{temp} + μ p )} ]}^{2} + {[ \frac{2 ( μ {p}_{temp} - μ p )}{( μ {p}_{temp} + μ p )} ]}^{2}}$$

$${μ}_{p} = {μ}_{p \_ temp} and {τ}_{0} = {τ}_{0 \_ temp}$$

At 74, a test is performed to determine if a new loop starting at 60 must be performed or if the iteration process is completed. If Var>Threshold, the loop 62 is restarted with these new parameters:

the current I_{turbulent}

μₒ=μₚ_{_}ₜₑₘₚ and τ₀=τ₀_{_}ₜₑₘₚ

Else, the iteration loop 62 is stopped and the set of values (μp and τ0) is the final determined rheological parameters. Other models of non-Newtonian fluid include power law and Hershel-Buckley or Casson. These have generally known trends. Mud can exhibit properties of any of these types of Newtonian and non-Newtonian fluids.

The pipe rheometer can be designed for optimized performance even when the liquid may be loaded with various types of solids and particles, such as LCM, barite, proppant. These particles may have tendency to separate from the main liquid phase when the liquid agitation and shearing is not optimum. With conventional or simplified design, these particles may create film of sedimentation and may even plug some system components. The following descriptions cover several embodiments of this invention to allow proper operation even with such liquids.

As first embodiment for this “particle loaded” fluid application, the potential particles (barite) sagging at low shear condition along the measurement pipe 28 is reduced and even suppressed by imposing a slow rotation of the measurement pipe 28. This measurement pipe 28 can be configured to rotate along its axis as shown by arrow B in FIGS. 6 and 7. In such implementation, rotation swivels 13a and 13b may be installed onto the measurement pipe 28. A small drive system 15 may generate the rotation of the measurement pipe 28. This small drive system 15 may be controlled by an external controller (not shown) or the computer 38. The rotation can be carried out to prevent settling of particulate matter within the measurement pipe 28. When rotating the measurement pipe 28 at up to a rate of 6 RPM no or negligible effect on the rheological measurements are obtained by the operation of the system 10. The rotation of the measurement pipe 28 may even be up to 10 RPM or 20 RPM. The rotation speed may be selected by the operator or the computer 38 in relation to the type of liquid being measured. In some embodiments the measurement pipe 28 can rotate in a single direction, and in other embodiments it can rotate first in one direction, then reverse the rotation back in the other direction. The measurement pipe 28 can be rotated continuously or in discrete movements subject to an external controller (not shown) or the computer 38. The rotation may be optimized to re-mix potential sediment-rich components of liquid during the transfer along the rheometer pipe 28. Such sedimentation may for example occur with drilling mud loaded with barite or frac fluid loaded with proppant.

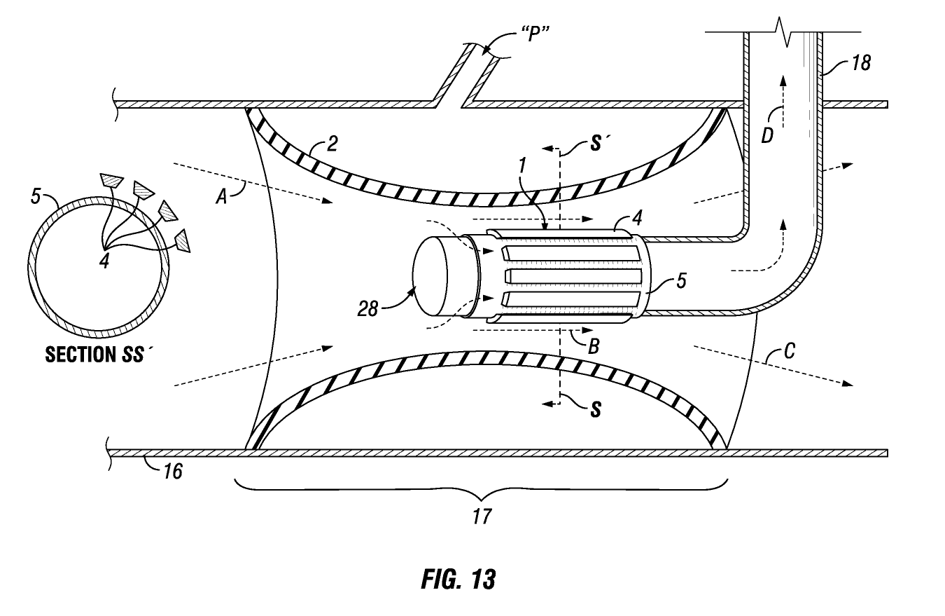

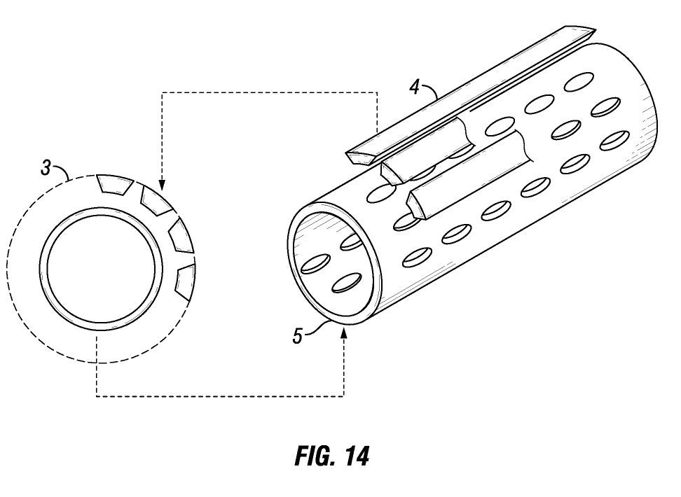

An additional embodiment to allow the pipe rheometer to operate properly with particles loaded liquid is to install a filter 17 to divert liquid without large particles into the diverter circuit 18, as shown in FIGS. 6 and 7. FIG. 13 is a cross-sectional schematic view of a filter 17 for use with the pipe rheometer according to embodiments of the present disclosure. FIG. 14 is a cross-sectional and perspective view of a base pipe 5 and trapezoidal wires 4 according to embodiments of the present disclosure. Referring now to FIGS. 13 and 14 together, the filter 17 ensures that the liquid directed in the rheometer via the diverter circuit 18 does not include particles or elements which could plug the measurement pipe 28. This filter 17 can be made by trapezoidal wires 4 which are installed in the base perforated tube 5. The spacing between this trapezoidal wires 4 defines the size of the particles which may pass through the filter 17. In case of need to reject elongated or flat particles, linear groves may be insufficient: in such case, small hole may be preferred. The external surface of the filter 17 is cleaned by the flow in the annular section “B”. By keeping the liquid velocity high enough in this zone “B”, the surface of the filter 17 is kept clean. The passage “B” is adapted to the total flow rate of the section “A”, while keeping the velocity in section “B” sufficiently high for cleaning. In one embodiment, this is achieved by using a deformable membrane 2 which is inflated by providing pressure “P”. This pressure may be created by compressed air or by another liquid such as hydraulic oil or even water. The membrane 2 may be made of rubber.

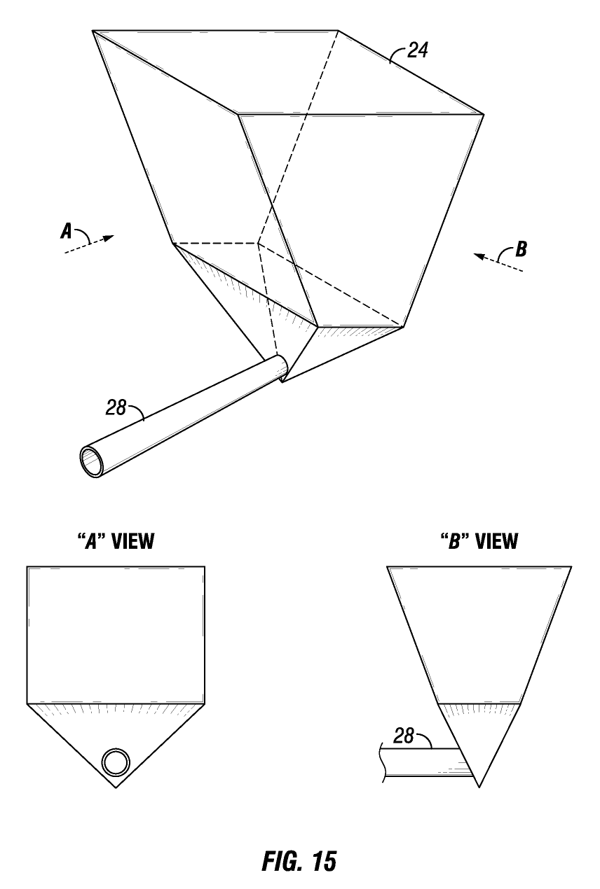

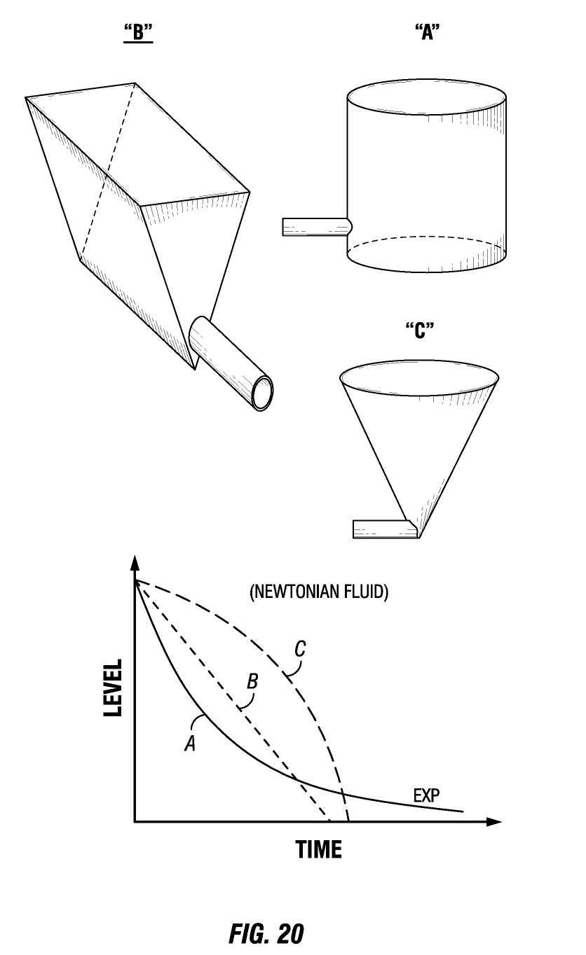

As a third embodiment of rheometer optimized to operate with particles loaded liquid is to insure the optimum drainage of the rheometer reservoir 24. The rheometer reservoir 24 can be shaped to ensure proper drainage of the liquid towards the measurement pipe 28. Potential design of such reservoir is shown in FIG. 15 and also the conical shape rheometer reservoir such as shown in FIG. 20. Furthermore, the connection of the measurement pipe 28 can be at the lowest part of the rheometer reservoir 24. With such design, the fluid will entrain the particles out of the reservoir at the end of each theology test sequence. This allows to perform the next sequence of rheology measurement with the reservoir properly drained.

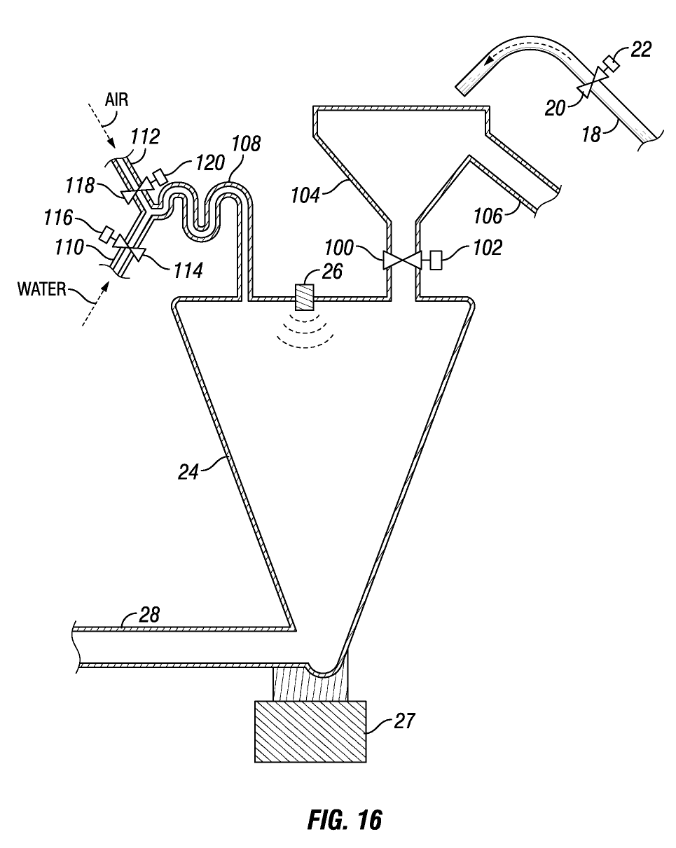

As an additional embodiment to improve the capability of performing multiple sequences of rheology measurements, the rheometer reservoir may be cleaned between successive sequences. FIG. 16 shows features of a reservoir 24 according to embodiments of the present disclosure which allow forced cleaning between different phases of filling of the rheometer reservoir 24. During the filling, the valve 100 is opened by an actuator 102. The filling is performed via the diversion line 18 which is controlled by the valve 20 and actuator 22 as discussed above with reference to FIGS. 6 and 7 above. There is a line 106 that acts as an overflow line to return any potential excess liquid to the main tank 12. During the drainage phase, the valve 100 is kept open. The measurements are performed with the level sensor 26 and weigh sensor 27. During filling and drainage, the valve 114 and 118 are closed. After the drainage, the valve 100 is closed and the cleaning fluid (i.e. water) is supplied via a line 110 through the valve 114 which is opened by the actuator 116. Then the valve 114 is closed and the drying line 112 is opened (valve 118 is open). Air may be blown through the reservoir 24 and the measurement pipe to dry the system. Finally, the valve 118 is closed and the valve 100 is open. The system is ready for the next measurement cycle.

It should be noted that the manifold (valve 114 and valve 118) can be connected to the reservoir 24 via an elastic deformable pipe section 108, so that the weight measurement 27 is not influenced by this piping. Some liquids to be handles by the pipe rheometer may need to be steered in the rheometer reservoir 24. Such steering provides agitation and recirculation in the rheometer reservoir. Such effects can be beneficial for proper rheology measurements, as gel cannot build in the liquid in the rheometer reservoir 24, and the fluid composition is kept quite uniform even when particles would sediment in static fluid.

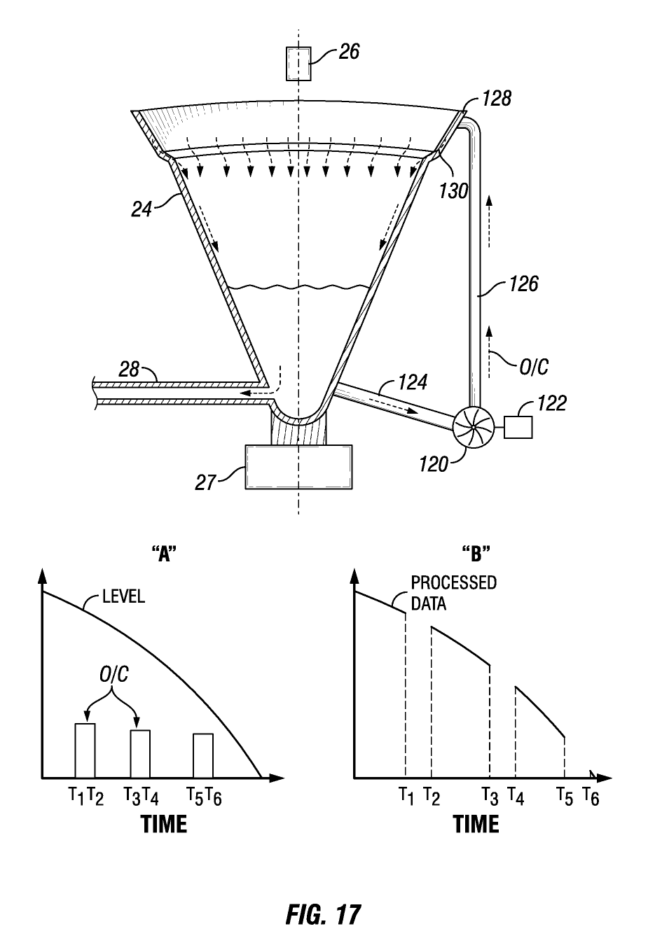

FIG. 17 is a cross-sectional schematic view of a reservoir 24 according to further embodiments of the present disclosure. The reservoir 24 can be equipped with a system to homogenize the liquid during the drainage phase. The reservoir 24 can include a pump 120 that is driven by a motor 122 to circulate liquid throughout the reservoir 24 via a port 130. This port may cover most of the periphery of the reservoir 24. A channel 128 ensures that the liquid is distributed to most or all of the port 130. The homogenization process may be discontinuous. It can be activated intermittently such as from T1 to T2, then from T3 to T4, then from T5 to T6 to coincide with times when data is not being taken. In some embodiments, the homogenization process can determine when data is taken, and in other embodiments the data taking can be scheduled around the homogenization process. When the homogenization process is active, the level in the reservoir 24 may not be steady because the surface of liquid may be agitated. The data may be ignored for the determination of the rheogram (as shown in “B”).

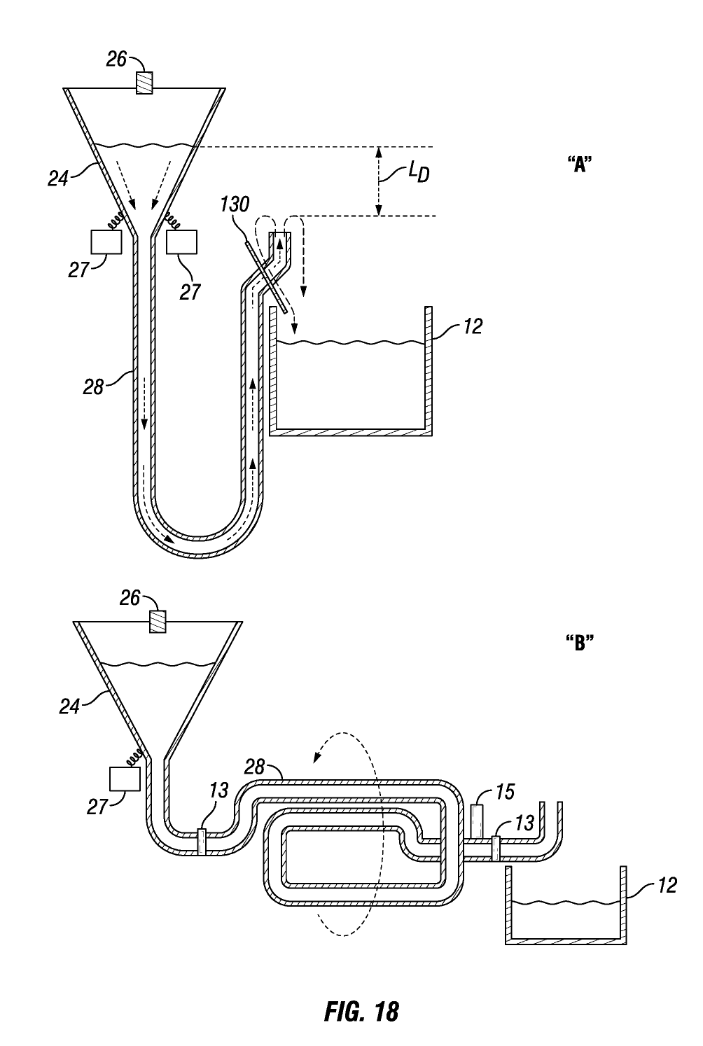

FIG. 18 is a schematic view of yet another configuration for the reservoir pipe 28 according to embodiments of the present disclosure. There are two configurations shown: A and B. In configuration A the measurement pipe 28 is vertical and U-shaped. The level Ld between the liquid in the reservoir 24 and the exit is the input to determine the head of the Poiseuille flow and the rheogram. The benefit of this embodiment is minimal or no sedimentation along the measurement pipe 28. To properly calculate the rheology using this configuration, the system should be installed at a certain elevation from the floor. The curve along the measurement pipe may create some perturbation into the apparent length of the pipe which differences can be accounted for in the calculations.

Configuration B is based on a wound measurement pipe 28 which allows the system to be smaller, or at least to fit into a smaller outer envelope. The measurement pipe 28 is coiled and may be rotated periodically or continuously to avoid sedimentation along the pipe. With some of the embodiments, the issue with separation of liquid component may be overcome by:
The shape of the reservoir such as in FIG. 15 to ensure full drainage of the liquid out of the reservoir;
A reservoir cleaning system may be included as such as in FIG. 16.
The homogenization system of FIG. 17 limits the effect of element separation within the rheometer reservoir 24;
The measurement pipe 28 may be rotated over its axis on the swivels 13 and the drive 15 as shown in FIGS. 6, 7 and 18 configuration B; or
The measurement pipe may have a U-shape such as in FIG. 18, configuration A.

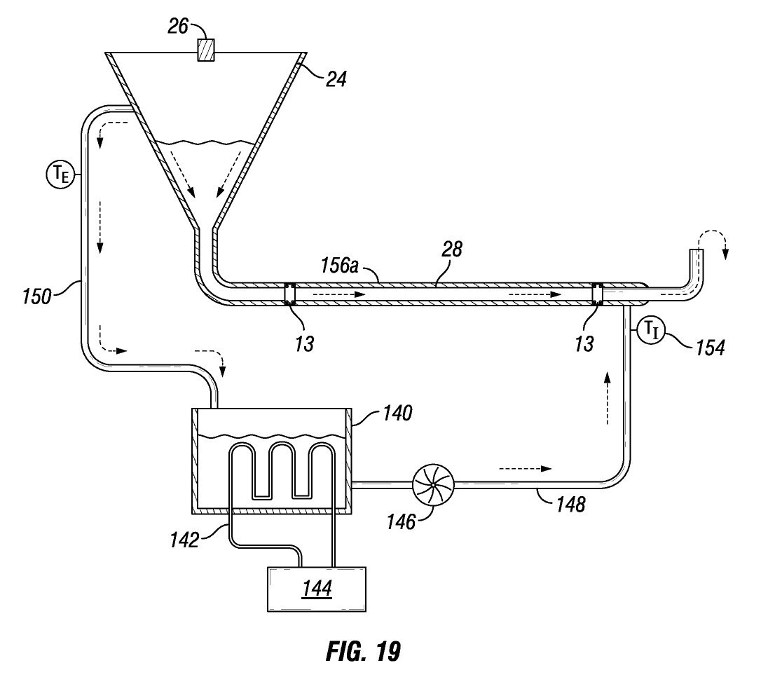

FIG. 19 is a cross-sectional schematic view of a pipe rheometer including a heating jacket according to embodiments of the present disclosure. Rheology is known to be strongly dependent upon the liquid temperature. To ensure that the liquid to be measured is at the correct temperature, a fluid jacket 158 and 156 can cover the installation. Thermally controlled fluid may be circulated in the jacket 158 and 156 by a pump 146. The temperature of this fluid is imposed in the reservoir 140 where a heating element 142 is operated under the control of a thermal probe 154.

Many of the liquids used in the oil and gas industry may be thixotropic. The rheology depends on the shear history. The shear history for the fluid during the rheology test is influenced by the residence time in the rheometer reservoir 24. Furthermore, the duration of the rheology test at a given shear level along the rheometer pipe 28 should be as constant as possible, as defined by most test procedure. FIG. 20 shows the effect of the shape of the rheometer reservoir 24 on the drainage process for the reservoir 24. With a Newtonian liquid. The shape “B” would ensure that the liquid is submitted for the same time test duration for each level of shear along the measurement pipe 28. Reservoir “C” may be preferred with non-Newtonian liquid, as the liquid used in drilling is mostly shear thinning (Bingham-plastic fluid or power-law with index <1). With such shear thinning liquid, the level response would approximately be linear and approach the response B for level versus time. The constant section reservoir “A” is not insuring a constant test duration for any type of fluid; furthermore, the residence time in the rheometer reservoir 24 increases drastically at the end of the rheology test, with the risk of gel building (if the liquid is thixotropic) and sedimentation of particles if the fluid is loaded with particles.

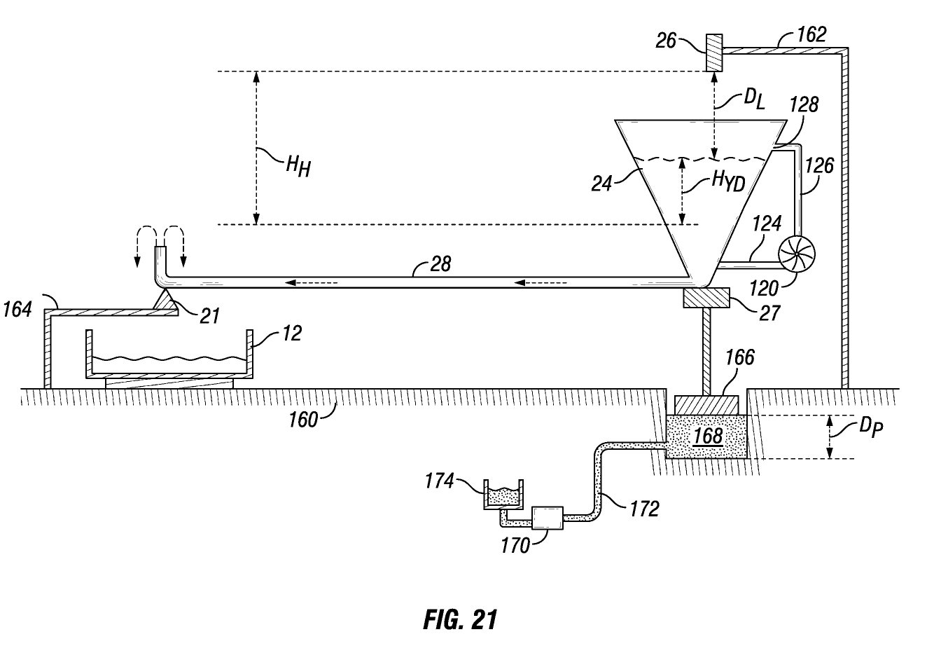

FIG. 21 is a cross-sectional schematic view of a pipe rheometer according to embodiments of the present disclosure. Many of the liquids used in the oil and gas industry may be thixotropic and may “gel” when left static. Such gelling property can be desirable to calculate because overcoming the shear stress caused by the gel is required for some equipment. For such “gel” measurement, the pipe rheometer is adapted as shown in FIG. 21. There is a hinge 21 located below an exit port of the measurement pipe 28. The rheometer reservoir 24 may be moved vertically by a piston 166 which may move upwards and downwards. This movement may be obtained by injection of hydraulic oil by a pump 170 in the cylinder 168 via the pipe 172. The level sensor 26 is supported by a support 162 attached to the rheometer base frame 160. The hinge 21 is also attached to the same frame 160. The rheometer may be equipped with the homogenization system made of the pump 120 and returning fluid into the reservoir 24 by an orifice 128. The weight of the rheometer reservoir 24 is monitored by the sensor 27. With such design, the liquid hydrostatic pressure Hyd is:

H_{yd}=HₕDl

With:

H_{yd}: the level to determine the hydrostatic pressure in the liquid at the entry of the measurement pipe 28;
Hₕ: the difference of elevation between the face of the level sensor and exit of the elbow; and
Dl: The measured distance by the level sensor (from sensor face to the liquid surface).

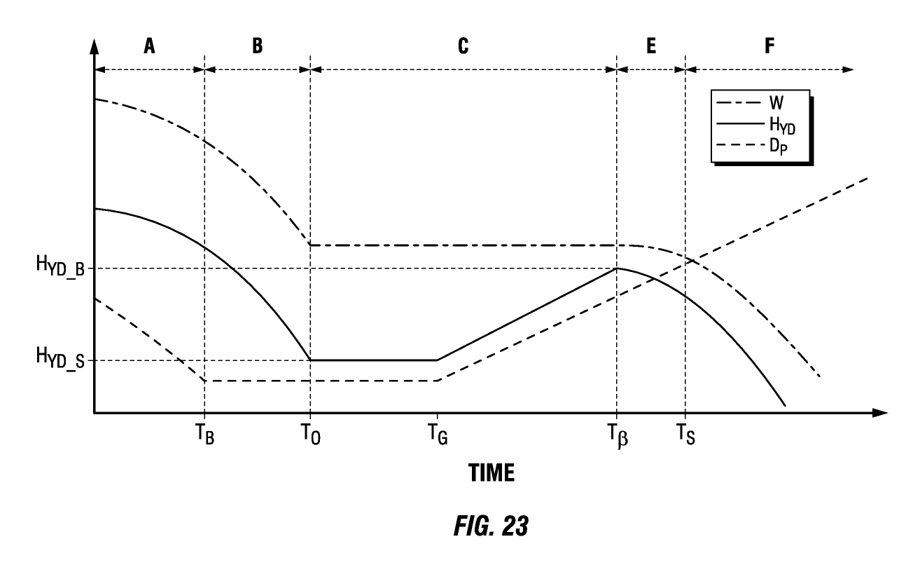

FIG. 23 shows four steps to determine the gel of the liquid according to embodiments of the present disclosure. These steps can be performed in a different order and any of the steps can be repeated as needed. This description is not limiting to the features of the disclosed embodiment. The first step (1) can be performed when the drainage stopped and the liquid level is H_{yd-s}. With fluid without yield point, the H_{yd-s} is null. The homogenization system is also stopped. In the next step (2) there is no movement and no homogenization and liquid may gel. In the next step (3) at time Tb, the piston has pushed the rheometer reservoir 24 upwards. If the liquid is gelled, there will be no flow through the measurement pipe 28 even in the presence of some hydrostatic pressure due to H_{yd-B}. In the next step (4) the liquid starts to move. The corresponding level allows determining the shear stress which is correlated to the amount of gelling that has taken place in the liquid.

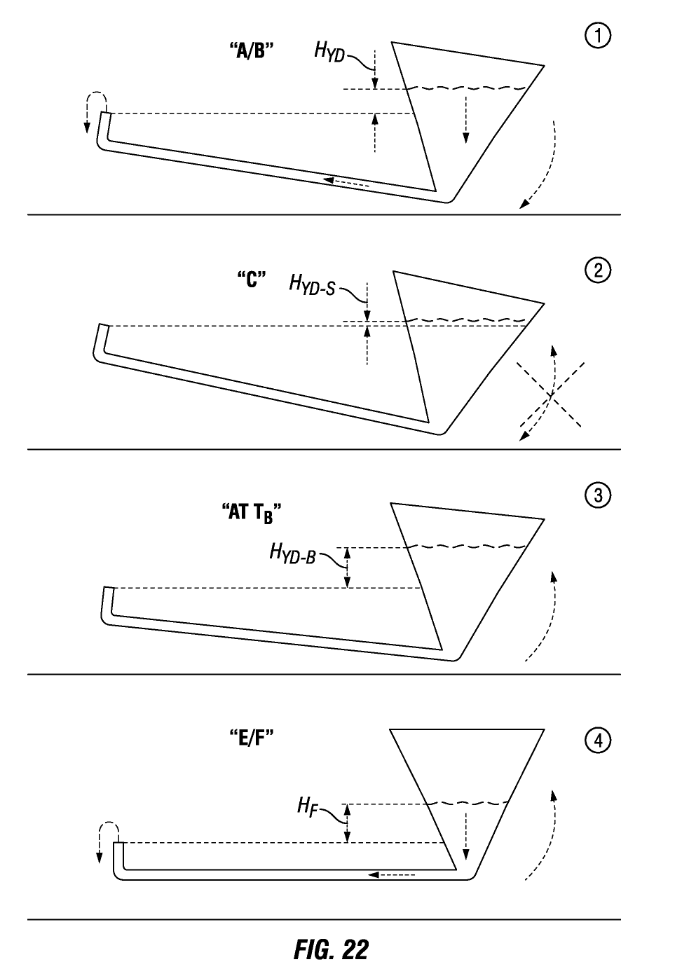

FIG. 23 is a graph representing the measurements performed by the sensor 26 and 27 during the gel acquisition sequence described in FIG. 22 according to embodiments of the present disclosure.

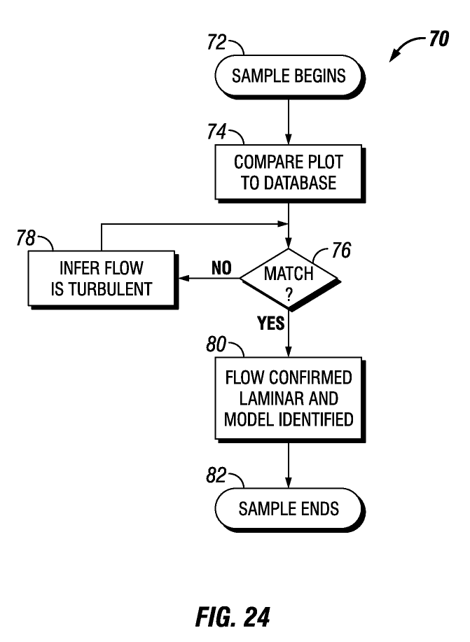

In some embodiments, the determination of the data in turbulent flow may be removed out of the global set of data. Such a method may require less computing time while being less accurate. FIG. 24 shows a flow chart diagram of a method 70 of confirming that the flow within a measurement pipe is laminar according to embodiments of the present disclosure. The equations and principles given above hold true so long as the flow within the measurement pipe remains laminar. The method 70 begins with a sample initiating at 72, similar to what was disclosed above. At 74, the rheological plot is known and can be compared to a given, known rheological model. The models can be stored in a database and can include known non-Newtonian models such as Bingham plastic, Hershel-Buckley, and power law models. At 76 the comparison is made. If there is no match, at 78 the flow can be inferred to be turbulent at that data point. As discussed above, the processes disclosed herein can be iterative using different times as the reservoir is drained for the sample. In some embodiments, if there is no match then the given data point can be discarded, ignored, or marked as not fitting a given rheological model. If there is a match at 80, the flow is confirmed to be laminar, and moreover the rheological model is known. At 82 the sample ends with a successful measurement of the rheological plot of the mud.

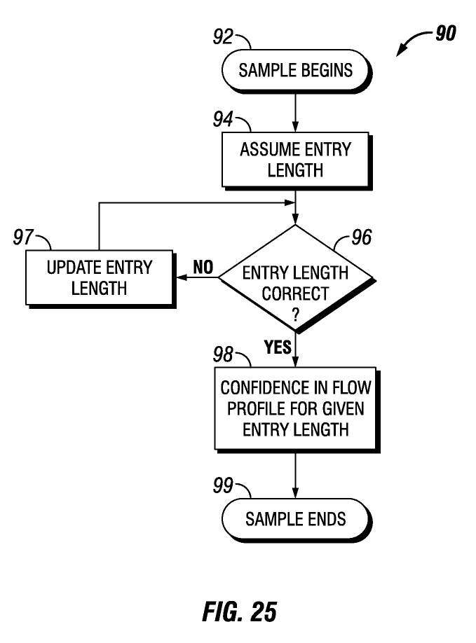

In some embodiments, the determination the effect of entry length may be simplified to avoid an iterative process. Such method may require less computing time while being less accurate. FIG. 25 shows yet another flow chart diagram of a method 90 for determining entry length for the measurement pipe according to embodiments of the present disclosure. In fluid dynamics, the entrance length is the distance a flow travels after entering a pipe before the flow becomes fully developed. Entrance length refers to the length of the entry region, the area following the pipe entrance where effects originating from the interior wall of the pipe propagate into the flow as an expanding boundary layer. When the boundary layer expands to fill the entire pipe, the developing flow become a fully developed flow, where flow characteristics no longer change with increased distance along the pipe. Many different entrance lengths exist to describe a variety of flow conditions. Hydrodynamic entrance length describes the formation of a velocity profile caused by viscous forces propagating from the pipe wall. Thermal entrance length describes the formation of a temperature profile. The sample can begin at 92 as disclosed elsewhere herein. At 94 an entry length can be assumed. Any number will do because the iterative process of the present disclosure is very likely to converge upon an entry length. At 96 the method includes determining whether or not the assumed entry length is correct. This can be achieved using a similar comparison to what was discussed with reference to FIG. 24, in which the plot of shear stress and shear rate were compared to known rheological models. At 96, if there is no match, the entry length can be updated at 97 and the check can be performed at the next iteration. If the entry length is correct, at 98 the method includes identifying confidence in the flow profile for a given entry length. The method 90 can repeat as necessary, using the iterations as the reservoir drains as discussed previously. In other embodiments the sample rate for the methods 70 and 90 of FIGS. 24 and 25, respectively, can be different than the sample rate for draining the reservoir.

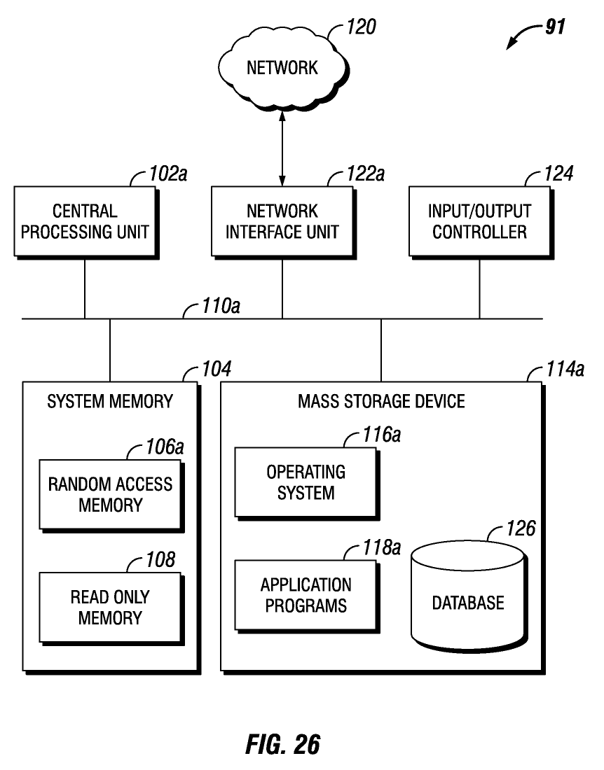

Referring now to FIG. 26, an illustrative computer architecture for a computer 91 utilized in the various embodiments will be described. The computation component 38 described in FIG. 1 can be just such a computer. The computer architecture shown in FIG. 30 may be configured as a desktop or mobile computer and includes a central processing unit 102 (“CPU”), a system memory 104, including a random access memory 106 (“RAM”) and a read-only memory (“ROM”) 108, and a system bus 110 that couples the memory to the CPU 102.

A basic input/output system containing the basic routines that help to transfer information between elements within the computer, such as during startup, is stored in the ROM 108. The computer 91 further includes a mass storage device 114 for storing an operating system 116, application programs 118, and other program modules, which will be described in greater detail below.

The mass storage device 114 is connected to the CPU 102 through a mass storage controller (not shown) connected to the bus 110. The mass storage device 114 and its associated computer-readable media provide non-volatile storage for the computer 91. Although the description of computer-readable media contained herein refers to a mass storage device, such as a hard disk or CD-ROM drive, the computer-readable media can be any available media that can be accessed by the computer 91. The mass storage device 114 can also contain one or more databases 126.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 91.

According to various embodiments, computer 91 may operate in a networked environment using logical connections to remote computers through a network 120, such as the Internet. The computer 91 may connect to the network 120 through a network interface unit 122 connected to the bus 110. The network connection may be wireless and/or wired. The network interface unit 122 may also be utilized to connect to other types of networks and remote computer systems. The computer 91 may also include an input/output controller 124 for receiving and processing input from a number of other devices, including a keyboard, mouse, or electronic stylus (not shown in FIG. 1). Similarly, an input/output controller 124 may provide output to a display screen, a printer, or other type of output device (not shown).

As mentioned briefly above, a number of program modules and data files may be stored in the mass storage device 114 and RAM 106 of the computer 91, including an operating system 116 suitable for controlling the operation of a networked personal computer. The mass storage device 114 and RAM 106 may also store one or more program modules. In particular, the mass storage device 114 and the RAM 106 may store one or more application programs 118.

The resulting systems and methods of the present disclosure enable a reliable plot of rheology for a given fluid at any desired sample rate, achieved via an automated system, and without the use of an expensive, delicate, and/or time and labor intensive device such as a Fann 35. Moreover, the sample is taken from any desired location with in the mud loop, and not just from the top. Other embodiments and features of the present disclosure will become clear to a person of ordinary skill in the art having the benefit of the present disclosure.

1. A system for measuring a rheological profile for a fluid, the system comprising:
a reservoir configured to receive a sample of the fluid, the reservoir having a height and a volume;
a measurement pipe operably coupled to the reservoir and configured to conduct fluid from the reservoir, the measurement pipe having an interior dimension and a length;
a pressure determination component operably coupled to the reservoir and configured to determine a pressure in the reservoir as it enters the measurement pipe at a plurality of different times as fluid leaves the reservoir;
a flow rate determination component operably coupled to at least one of the measurement pipe and the reservoir and configured to monitor a flow rate through the measurement pipe;
a sequencing component configured to sequence filling of the reservoir followed by gravity drainage of the reservoir at drainage rate reducing during the drainage phase;
a data acquisition system configured to determine a pressure and flow-rate at various discrete times during the drainage of the fluid from the reservoir and after filling of the reservoir;
a computation component configured to create a plot of shear stress and shear rate from the variables P, pressure taken at the plurality of different times by the pressure measuring component, Q, the flow rate measured by the flow rate measuring component.

2. The system of claim 1 wherein the computation component is configured to:
perform successive rheology determination cycles on multiple fluid samples;
ensure the reservoir is filled to a predetermined level; and
commence filling of the reservoir when the fluid of the previous test is drained out of the reservoir.

3. The system of claim 2, further comprising a digital controller and sensor indicate the amount of fluid in the reservoir, wherein the system is configured to rely on data from the digital controller.

4. The system of claim 1 wherein the fluid is one or more of a drilling mud, cement slurry, brine, or frac fluid.

5. The system of claim 1 wherein the level of the fluid in the reservoir is determined versus time.

6. The system of claim 1 wherein the density of the fluid in the reservoir is determined versus time.

7. The system of claim 1 wherein the weight of the reservoir filled with liquid is measured versus time.

8. The system of claim 1, further comprising a Coriolis flow sensor configured to measure a mass flow rate and fluid density.

9. The system of claim 6 wherein the fluid density is also provided to the computation component, wherein the computation component is further configured to derive the pressure drop along the rheometer pipe for various times of the drainage period.

10. The system of claim 5 wherein the computation component is configured to determine the variation of fluid volume versus drainage time, and wherein the computation is further configured to determine a flow-rate through the rheometer pipe for one or more times.

11. The system of claim 1 wherein the measurement pipe is configured to rotate about a longitudinal axis.

12. The system of claim 6 wherein the measurement pipe is configured to rotate at a rotational rate up to 10 rotations per minute.

13. The system of claim 1, further comprising a fluid diverter circuit fluidly coupled to the fluid and configured to divert the sample of the fluid to the reservoir.

14. The system of claim 1, further comprising at a sensing component operably coupled to the measurement pipe and configured to measure a characteristic of fluid flow over a defined length of the measurement pipe.

15. The system of claim 14, where the sensing component can be moved along the pipe.

16. The system of claim 14, further comprising an array of sensors can coupled to the measurement pipe.

17. The system of claim 14 wherein the sensing component comprises an acoustic sensor.

18. The system of claim 14 wherein the sensing component comprises thermal probes.

19. The system of claim 14, wherein computation component is configured to determine an entry length based on the output of the sensing component.

20. The system of claim 1 wherein the computation component is configured to iteratively solve for the fluid rheology and the entrance length for each flow rate in the measurement pipe based on predetermined knowledge of entrance length versus the combined effects of fluid rheology, instantaneous flow-rate and pipe entry geometry.

21. The system of claim 1 wherein the computational component is configured to obtain an entry length from a predetermined database based on flow-rate and a previously-fitted rheology model and, based at least in part upon the comparison, identify whether the variation of computed results such as entry length and rheology model for two successive iterations are smaller than predetermined threshold so that that the iterative process can be stopped.

22. The system of claim 1 wherein the computation component is configured to:
iteratively resolve rheology model and flow regime based on the measurements data set;
determine the rheology determination of the data in laminar flow;
stop iterating when the variation of critical flow rate for the upper limit of laminar flow based on the fitted rheological model is lower than pre-determined value.

23. The system of claim 22 wherein the computation component is configured to determine an upper limit of laminar flow based on predetermined results of flow in pipe.

24. The system of claim 1, further comprising an external displacement system configured to control a fluid head to generate shear stress along the measurements pipe.

25. A method of measuring a rheological graph of a fluid, the method comprising:
retrieving a sample of fluid from a body of fluid;
at least partially filling a reservoir with the sample of fluid;
draining the sample of fluid from the reservoir through a measurement pipe;
monitoring a level of fluid in the reservoir as the reservoir is drained, thereby determining a flow rate through the measurement pipe;
identifying a pressure within the reservoir at a plurality of measurements as the reservoir is drained;
calculating a shear stress for the sample of fluid from the identified pressure drop along rheometer pipe;
calculating a non-Newtonian factor, n′ from the pressure drop and flow rate along the rheometer pipe;
calculating a shear rate from n′ and the flow rate; and
obtaining the rheogram of the fluid as a relation of shear stress versus shear rate.

26. The method of claim 25 wherein the fluid is used for an operation, the method further comprising altering a portion of the operation in response to the rheological graph.

27. The method of claim 25 wherein identifying the pressure comprises weighing the reservoir full and subtracting the weight of the empty reservoir.

28. The method of claim 25 wherein identifying the pressure comprises the determination of the fluid density and combining it with fluid level measurements in the reservoir.

29. The method of claim 28, wherein a Coriolis flow-meter is used along the measurement pipe to determine the fluid density and the flow rate.

30. The method of claim 25, further comprising returning the sample of fluid to the body of fluid.

31. The method of claim 25 wherein the fluid is a drilling mud or brine or cement slurry or frac fluid.

32. The method of claim 25 wherein the method is initiated and carried out in response to a remote command in the form of an electrical signal.

33. A system for measuring rheological properties of a drilling mud for use with a drilling operation, the system comprising:
a mud tank and mud circuit, wherein the mud tank holds the drilling mud and the mud circuit circulates the drilling mud from the mud tank to a drilling region and back to the mud tank;
a mud diverter circuit fluidly coupled to the mud circuit and configured to retrieve a sample of the drilling mud from the mud circuit at a region proximate to the drilling region;
a reservoir configured to receive the sample from the mud diverter circuit, the reservoir being further configured to determine a pressure within the mud in the reservoir and a level of fluid in the reservoir;
a measurement pipe fluidly coupled to the reservoir and configured to drain the drilling mud from the reservoir; and
a calculation component configured to plot shear stress against shear rate of the drilling mud of the sample from the pressure and the level.

34. The system of claim 33, further comprising a valve and a controller configured to permit drilling mud to enter the reservoir upon receiving an appropriate command.

35. The system of claim 32 wherein a filter is installed at the entry of the diverter line so that large particles form the main mud system cannot enter in the rheometer.

36. The system of claim 33, further comprising a rotatable joint coupled to the measurement pipe and configured to rotate the measurement pipe about a longitudinal axis.

37. The system of claim 33, wherein the reservoir is configured to determine the pressure within the mud in the reservoir using at least one of a weight of the reservoir, a density of the fluid in the reservoir, or a density obtained from a mass flow rate Coriolis system.

38. The system of claim 25, further comprising a pressure management component configured to provide sufficient fluid head such that flow through the rheometer pipe can be controlled by the rheometer control system.

39. The system of claim 38 wherein a fluid gel can be determined by determined the minimum fluid head to start the flow through the rheometer pipe.
